(19) United States
(12) Patent Application Publication
(10) Pub. No.: US 2005/0028008 A1
(43) Pub. Date: Feb. 3, 2005

(54) System for accessing digital assets

(76) Inventor: Anil N. Kumar, North Andover, MA (US)

Correspondence Address: GORDON E NELSON;PATENT ATTORNEY, PC, 57 CENTRAL ST, PO BOX 782, ROWLEY, MA, 01969, US

(21) Appl. No.: 10/902,622

(22) Filed: Jul. 29, 2004

Related U.S. Application Data
(60) Provisional application No. 60/490,869, filed on Jul. 29, 2003.

(51) Int. Cl. H04L 9/00

(52) U.S. Cl. 713/200

(57) ABSTRACT

A system for accessing digital assets. The system includes an access control mechanism that permits specification of one of a number of kinds of access by a particular user to a particular asset. The access control mechanism permits determination of what assets a given user may access quickly enough so that the determination may be made every time a user performs an operation on an asset. The user interface for the system is thus able to show a given user only those assets to which the user currently has access. The assets have owners and the assets belonging to an owner are organized into a hierarchy belonging to the owner. The owner of an asset may give other users access to individual assets. Such assets are termed shared assets. Once a user has logged onto the system, the user can access his own assets and those that have been shared with him without further credentials. When a user has access to a shared asset, the user interface for the system shows only that portion of the owner's hierarchy which is necessary for the user to reach the shared asset. The user interface further indicates whether a user has seen an asset since the user was given access to it.

### CROSS REFERENCES TO RELATED APPLICATIONS

The present patent application claims priority from U.S. Provisional Patent Application 60/490,869, Anil N. Kumar, A Digital Assets Management, Sharing and Communicating Service with Ubiquitous Access for its Members, filed Jul. 29, 2003. That provisional patent application is further incorporated by reference into the present patent application.

### BACKGROUND OF THE INVENTION

1. Field of the Invention

The invention relates generally to storing and sharing files and photos, exchanging personal information like address, telephone number, and scheduling information, and providing communications media such as email and instant messaging.

2. Description of Related Art

As we enter the 21^{st} century, the phenomenon of “digital convergence” will hit small businesses and consumers alike, like a Tsunami. One of the fundamental changes users will experience due to the digital convergence is the need to convert ALL information, be it personal or business data, images, audio, or video, into digital form. This need will accelerate the rate of growth in digital storage. Another fundamental change that will come with digital convergence is that almost everyone will have low cost, high-speed access to the Internet.

A problem with the conversion is that everyone, not just large corporations or governmental organizations, will need to manage huge masses of information and share the information with others. The others may include family, friends, and colleagues. At present, a user of a computer system has two choices for obtaining extra storage:
purchasing more local storage; or
using Web storage services.

Local storage for large amounts of data has become cheap in historical terms; for example, a LAN file server which has one 120 GB drive and to which another 120 GB drive may be added currently costs around $500.00. The problem with the local storage is making the data on it accessible to people who are not connected to the LAN. Subject to size limitations, data can always be sent as an email attachment to someone else, but the other person cannot access the data in the local storage on his own initiative. In order for the other person to have such access to data in the local storage, the owner of the data must currently maintain a Web site or provide remote access to the owner's system to those the owner wishes to share data with.

Web storage services that permit the user to share the stored assets with other users are currently limited to services that permit sharing of specific kinds of data, for example files and photos. Because different services allow sharing of different kinds of data, the owner of the data cannot share all of his data at one location, and those with whom the owner of the data wishes to share the data must know which of the services has a given piece of data.

Finally, neither giving those with whom the owner wants to share data access to local storage nor informing them of services that contain the data lets the people with whom the data is being shared see immediately what has been added to the shared data. Presently, one has to inform the people with whom the data is being shared of the new shared data by either email or telephone.

What is needed is a service that allows the storing of all types of digital assets in a single place and communication between users of the service. The service should be available to everyone and access to the service should require no modification of the system of the person accessing the service. Also needed is a simple graphical user interface (GUI) that will enable the owner of a digital asset to provide different kinds of access by particular users of the system to particular assets. A user should be able to share his assets by allowing sharers of them to not just view the assets, but also to add, delete and manage any or all of them as required for the kind of collaboration taking place between the owner of the asset and the persons he is sharing it with. Further, there needs to be a non-intrusive way to let a user of the service know that there is new/modified information in one or more of the assets the user has been given access to and to guide the user to the specific asset, even when the asset is buried deep in a hierarchy of assets. Lastly, a user should be able to create different groups of people with whom he/she can share particular assets and with whom he/she can communicate. It is an object of the invention to provide a service which has the above characteristics.

### SUMMARY OF THE INVENTION

The object of the invention is attained in one aspect by a system in which users may access digital assets. The system includes an access relationship representation, an access checker, and an interactive user interface. The access relationship representation represents access relationships between the assets and the users. An access relationship indicates one of a plurality of kinds of access by a particular user to a particular asset. The access checker employs the access relationship representation to produce a determination of what assets a given user may access. The interactive user interface includes an asset access interface. The asset access interface employs the access checker to produce the determination of what assets the given user can access whenever the given user uses the asset access interface and uses the determination to indicate to the given user only those particular assets which the given user may currently access. The user interface further notifies the given user when there is a change in the assets to which the given user currently has access, The given user may access any asset to which the given user has access using only the credentials necessary for the given user to gain access to the system. Access by the users to the system may be via a Web browser.

In the system, the access relationship for a particular user and a particular asset indicates whether the particular user has accessed the particular asset since the access relationship between the particular user and the particular asset was established and the asset access interface indicates assets which the given user has not yet accessed differently from other assets that the user may currently access.

The system further organizes the assets into a number of hierarchies. The kind of access which a particular user has to a particular asset may be inherited from an asset to which the user has access which is above the particular asset in the hierarchy. The hierarchies belong to users of the system who control storage in the system. The user to whom the hierarchy belongs is the owner of the assets in the hierarchy.

The kinds of access relationships include an access granting relationship which permits a particular user having that relationship to a particular asset to give access to the particular asset to another user and the interactive interface includes an access granting interface. A given user with an access granting relationship to a given object can use the access granting interface to establish an access relationship in the access relationship representation which gives another user access to the given asset. The relationship may be an access granting relationship. The owner of an asset has an access granting relationship to the asset. The assets include group objects that represent sets of users of the system and the given user may use the access granting interface to specify that the set of users represented by a given group object be given access to a given object.

Other objects and advantages will be apparent to those skilled in the arts to which the invention pertains upon perusal of the following Detailed Description and drawing, wherein:

### BRIEF DESCRIPTION OF THE DRAWING

FIG. 1 is an overview of the system, and shows how the users and system are connected over the Internet. It also shows the high-level components that make up the system;

FIG. 2 is a flowchart that shows the entire process by which a user interacts with the system;

FIG. 3 is a flowchart that shows how the attributes for an asset can be modified;

FIG. 4 is a flowchart that shows how access control attributes can be modified for an asset;

FIG. 5 is a typical scenario of how the users might use this service;

FIG. 6 shows typical Directory or Tree Hierarchy with the system's UASAO access model superimposed as white boxes in the shaded node areas;

FIG. 7 shows a symbolic representation of a standard access control list (ACL);

FIG. 8 shows a symbolic representation of the User Access Asset Owner (UAAO) access control Model;

FIG. 9 shows a symbolic representation of User Access Seen Asset Owner (UASAO) access control Model;

FIG. 10A shows the schema for the Assets table in database 130;

FIG. 10B shows the schema for the User Account table in database 130;

FIG. 10C shows the schema for the User Profile table in database 130;

FIG. 10D shows the schema for the Asset User Access table in database 130;

FIG. 10E shows a query to find all the UserNames of shared users;

FIG. 10F shows a query to find if an asset has been seen by the current user;

FIG. 11A is a screen shot of User X's MyPlace (Home Page) in a preferred embodiment;

FIG. 11B is a screen shot of User X's Folders, as shown in User X's My Folders view;

FIG. 12A is a screen shot of User X's My Folders view showing the dropdown menus for folders;

FIG. 12B is a screen shot of the User X's My Folders view showing the dropdown menus for folders;

FIG. 13A is a screen shot of the User/Asset Attribute modification Window for a create folder operation;

FIG. 13B is a screen shot of the Entity Attribute modification Window for an upload file operation;

FIG. 13C is a screen shot of the Entity Attribute modification Window for a delete file operation;

FIG. 14 is a screen shot of an Asset Attribute modification Window for an access modification operation on a folder;

FIG. 15 is a screen shot of an Entity Attribute modification Window for an access modification operation on a file;

FIGS. 16-37 are a series of screen shots of MyPlace, MyFolder and Shared Folder drilldown views of the tree of User X's assets as seen by User X and other users with whom User X has shared assets;

FIG. 16 (16X) is a screen shot of MyPlace, as seen by User X when User X has logged onto the system;

FIG. 17 (16-0) is a screen shot of MyFolders view, as seen by User X when User X has clicked on MyFolders;

FIG. 18 (16X-1A) is a screen shot of Folder 1A view, as seen by User X when User X has clicked on Folder 1A;

FIG. 19 (16X-2A) is a screen shot of Folder 2A view, as seen by User X when User X has clicked on Folder 2A;

FIG. 20 (16X-3A) is a screen shot of Folder 3A view, as seen by User X when User X has clicked on Folder 3A;

FIG. 21 (16X-3C) is a screen shot of Folder 3C view, as seen by User X when User X has clicked on Folder 3C;

FIG. 22 (16X-1B) is a screen shot of Folder 1B view, as seen by User X when User X has clicked on Folder 1B;

FIG. 23 (16X-2B) is a screen shot of Folder 1B view, as seen by User X when User X has clicked on Folder 2B;

FIG. 24 (16X-3B) is a screen shot of Folder 3B view, as seen by User X when User X has clicked on Folder 3B;

FIG. 25 (16X-2C) is a screen shot of Folder 2C view, as seen by User X when User X has clicked on Folder 2C;

FIG. 26 (16A) is a screen shot of MyPlace, as seen by User A when User A has logged onto the system;

FIG. 27 (16A-X) is a screen shot of User X's Shared folders view, as seen by User A when User A has clicked on User X's Shared folders;

FIG. 28 (16B) is a screen shot of MyPlace, as seen by User B when User B has logged on to the system;

FIG. 29 (16B-X) is a screen shot of User X's Shared folders view, as seen by User B when User B has clicked on User X's Shared folders;

FIG. 30 (16B-1B) is a screen shot of User X's Shared Folder 1B view, as seen by User B when User B has clicked on Folder 1B;

FIG. 31 (16B-2B) is a screen shot of User X's Shared Folder 2B view, as seen by User B when User B has clicked on Folder 2B;

FIG. 32 (16B-3B) is a screen shot of User X's Shared older 3B view, as seen by User B when User B has clicked on Folder 3B;

FIG. 33 (16C) is a screen shot of MyPlace, as seen by User C when User C has logged on to the system;

FIG. 34 (16C-X) is a screen shot of User X's Shared folders view, as seen by User C when User C has clicked on User X's Shared folders;

FIG. 35 (16C-1A) is a screen shot of User X's Shared Folder 1A view, as seen by User C when User C has clicked on Folder 1A;

FIG. 36 (16C-2A) is a screen shot of User X's Shared Folder 2A view, as seen by User C when User C has clicked on Folder 2A; and

FIG. 37 (16C-3C) is a screen shot of User X's Shared Folder 3C view, as seen by User C when User C has clicked on Folder 3C.

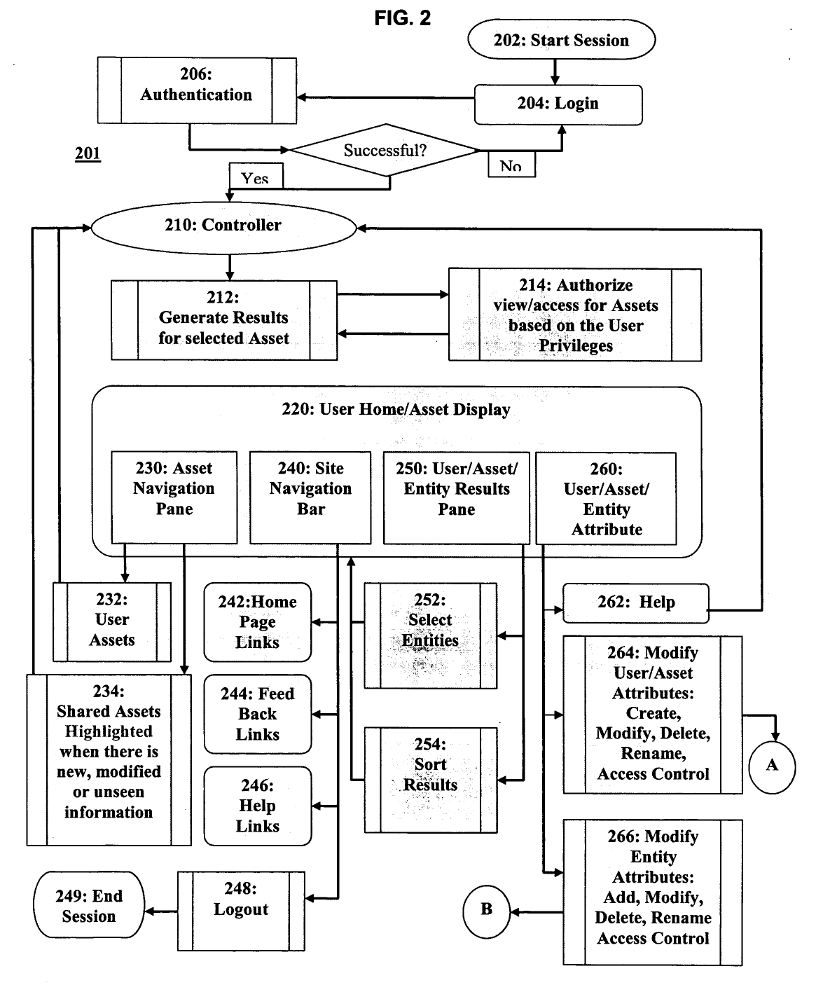

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

The following Detailed Description will begin with a functional overview of the system for accessing digital assets and will then describe a presently-preferred embodiment of the invention.

### FUNCTIONAL OVERVIEW

The system is an access controlled, secure, and custom environment that allows users of the system to do the following:
store digital assets which they own on the system;
share access to assets belonging to the user that are stored on the system with other users of the system; the shared access may range from read only access to access which gives the other user the same rights as the owner; and
have a workspace that is accessible by a single set of credentials in which all of the assets belonging to the user or shared with the user by other users and only those assets are available to the user.

Access control is at the level of specific assets and specific users. A digital asset is defined for present purposes as anything that can be stored and retrieved from a computer. Digital assets thus include files like texts, documents, zip files and executables as well as multimedia files like graphics, images, photos, audios and videos. Digital assets also include objects used by the system for management of the digital assets. Examples of such objects are folders that organize other folders into a hierarchy of assets, user profiles that describe users of the system, objects that describe groups of users, and objects that simplify time management for users.

When a user of the system logs onto the system, what the user sees is a per-user workspace in which those digital assets appear to which the user has access. The user has access to a digital asset either because the user is the owner of the asset or because some other user of the system who had the right to do so gave the user access to the asset. Assets to which a user has been given access by another user are termed herein shared assets. If a user decides to revoke the access he gave to the other user, the only effect on the other user is that the other user no longer sees the data to which the other user gave him access. Users of the system are peers; they differ from each other only with regard to access rights to particular assets.

A user of the system becomes an owner of an asset either because the system created the asset for him or her or because the asset is stored in storage in the system that belongs to the owner. The owner may himself have stored the asset in the storage or another user with the proper access may have stored the asset in the owner's storage.

Only those digital assets to which the user has access appear in the user's workspace. Determination a user's access rights is done each time the system performs an operation for a user that involves an asset. Consequently, the system applies only the most recent access rights to determine what assets are seen by the user and what kind of access the user has to a particular asset. The system organizes all of the assets into hierarchies, one for each owner of assets in the system. What a given user sees in his workspace is the hierarchy of assets that he owns and hierarchies for each of the other users who have given the given user access to assets that the other user owns. Each hierarchy for an other user shows only those assets that the other user has shared with the given user. The given user may access an asset at any level of any of the hierarchies that the given user sees in his workspace. Permitting a user to see hierarchies of only those assets which the user may access and allowing the user to access any asset at any level of these hierarchies is extremely helpful to users who are not familiar with typical computer operating systems or read, write and delete privileges. When the given user has been given access to a digital asset but has not performed an operation on the digital asset since being given access to it, the system displays the part of the hierarchy for the owner of the asset which contains the asset in a different manner from the remainder of the owner's hierarchy. This makes it easier for the given user to drill down through the owner's hierarchy to the asset.

An owner of a digital asset may provide access to any of his or her digital assets to any other user of the system. There are five types of access attributes, namely: 1) Read, 2) Read and Write, 3) Read, Write and Delete, and 4) Full. The Full access right allows users who have it to modify access to the asset as well as to read, write, and delete the asset. The system originally gives Full access to the owner of the asset, and the owner may give Full access to other users. If a particular user has not explicitly been given access to a particular asset, the particular asset may inherit access by the particular user from a folder asset which is higher in the hierarchy. The inherited access comes from the folder asset in the hierarchy which satisfies two requirements:
the particular user has explicitly been given access to the folder asset; and
the folder asset is the first folder asset in the hierarchy above the particular asset to which the particular user has been explicitly given access.

All a user with full access needs to know to give another user access is the desired kind of access, the asset, and the user's username. The user can thus provide access to all of his/her digital assets in his or her entire hierarchy, to just to one file (leaf node), or to any sub portion of the hierarchy.

Users of the system may send implicit or explicit messages to other users of the system. An example of an implicit message is the notification to a user that he or she has been given access to an asset. Users may send explicit messages to other users individually or to groups defined in group assets. All that is required to send a message to another user is the name by which the user is known to other users of the system. Messages may also be broadcast to a group of users.
As implemented, the system employs WWW technologies. The system may be implemented as a Web server and access to it is by any industry standard web browser. The graphical user interface that appears in the browser is simple. Any person who can browse the Internet can use the system. The GUI provides access-based drill down navigation and context sensitive dropdown menus. In addition, the system provides links to both internal and external sites.

### DESCRIPTION OF A PRESENTLY-PREFERRED EMBODIMENT

The following Description of a presently-preferred embodiment will begin with an overview a preferred embodiment of the system and a description of the user interface and interaction in the preferred embodiment. Also, a detailed description of access control model will be discussed. It will then describe an implementation of this service, with the necessary database tables that will be needed to implement access control and authorization of digital assets.

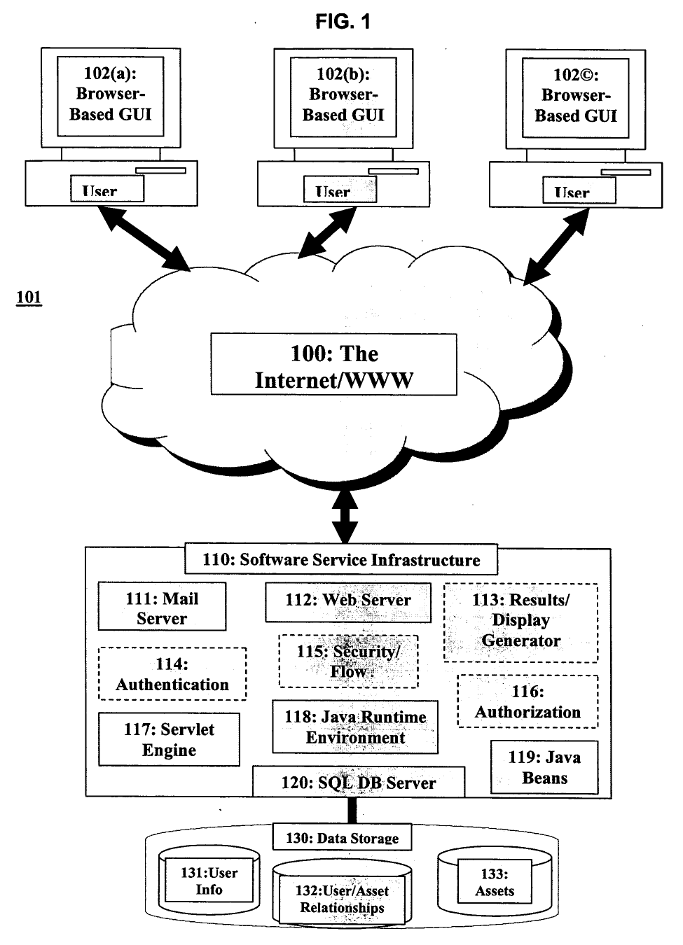

Overview of the System: FIG. 1

FIG. 1 is a global view of an implementation 101 of the system as a service over Internet 100. Internet implementation 101 is of course accessible from anywhere by anyone who has a browser on his system and knows the URL of implementation 101's Web site. Implementation 101 can also be deployed as a stand-alone intranet service, dedicated to a single organization. Software service infrastructure 110 is the heart of implementation 101. Service 110 is a service executing on a Web server. Industry standard components of service 110 include: SMTP mail server 111, Apache Web Server 112, Java Runtime Environment 118, Tomcat Servlet Engine 117, Java Beans 119 and a SQL Database Server 120. The mail server 111 is used to communicate with the users, starting with sending out passwords to new users and allowing users to send email messages to other users directly from system 101. Users cannot send email to the system. At the front end of service 110, Web Server 112 handles all the HTTP transactions resulting from browser-based client interactions with service 110. In the middle is JRE 118, which is at the heart of this system and which manages the Java code and the Tomcat Servlet Engine 117 which process the JSP code. This implementation depends heavily on Java and JSP in addition to the HTML, Java Script, and SQL languages. At the back end, there is a SQL database server 120 to handle all the interactions with the database itself. Server 102 server interacts with JRE 118 via JDBC.

Additional components required to implement the invention in service 110 include: User Authentication 114, Asset Authorization 116, Results Generator 113, and Security/Flow controller 115, which is the central part of the system navigation. Authentication 114, as implemented, is based on a “username” which is unique to the entire system and a “password”. If there is additional authentication needed, it can be easily implemented as a plug-in added to service 110. Asset Authorization 116 determines dynamically whether a particular user may access a particular asset and how the user may access the asset. Asset authorization is done on every operation which service 110 performs on an asset for a user. Results/Display generator 113 will display only assets that the user has rights to access at the time the user performs an operation on the asset. A given user may specify user environment-specific attributes for the screens which Result/Display generator 113 displays for the given user. The attributes include as banners, colors, links, and the like. These attributes are dynamically generated based on the profile of the user for whom Results/Display generator 113 is generating results. Also, any user specific messages will be dynamically searched and presented at the appropriate places. Lastly, and more importantly, each and every time the user specifies that an operation be performed, the specification for the operation goes through the Security/Flow controller 115, which makes sure that the user has the access necessary to perform the operation. If the user does not have the necessary access or if the user's session has timed out, the controller will redirect the user to the Index or the Login page.

Data Storage 130

Data Storage 130 may be implemented in system 101 by any industry standard relational database management system (RDBMS). What is used in the preferred embodiment is a MySQL Server using an SQL query interface via JDBC. In the current implementation the database is located on the same machine as service 110, but data storage 130 may be at any location where it is accessible to service 110. In the current implementation, data storage 130 includes user info 131, including authentication data, user assets 133, and authorization information 132. The implementation of data storage 130 permits addition of new kinds of user assets 133 as required.

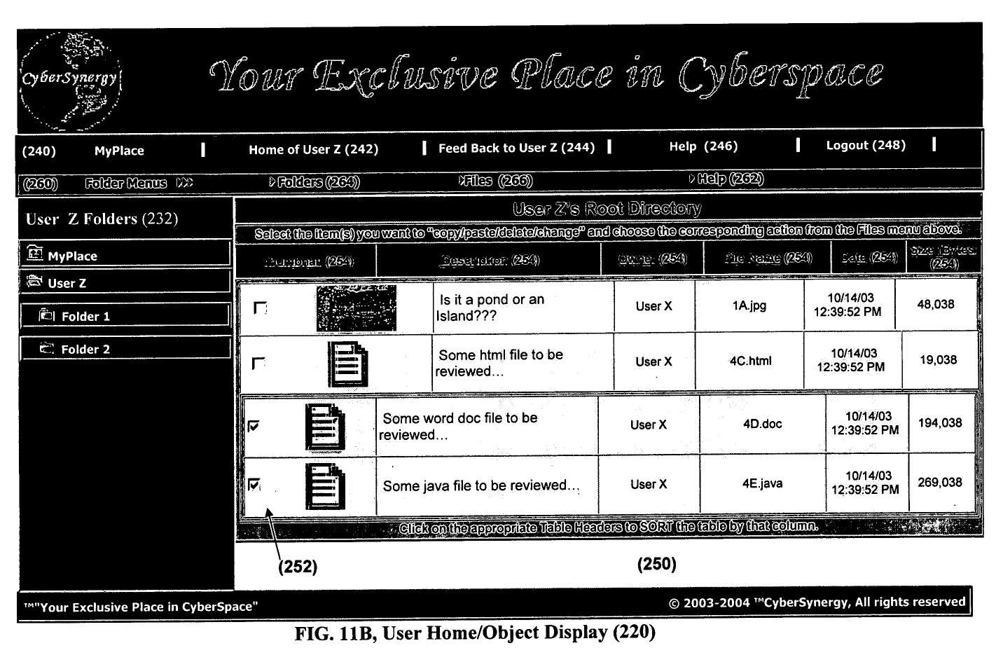

Functional Overview of System 101: FIG. 2, FIG. 11A, and FIG. 11B

FIG. 2 is a flowchart 201 which shows how a user of system 101 typically interacts with service 110. FIGS. 11A and 11B are screenshots of the user interaction with service 110. A user starts his interactive session by typing in the URL for service 110 on any standard browser. This will direct the user to a Login window 204. The user needs to enter both “username” and a “password” to login or get access to service 110. Authentication module 206 verifies that this is indeed a valid username and that the password matches the password stored in the database. If the login is successful, Authentication module 206 will redirect the interaction to Controller 210. If the login fails, the interaction will be redirected to Login window 204 and the window will include an explanation for the failure.

Controller 210 is the central module of this system, and each and every click received from the user or refresh performed for the user always goes through the Controller. The first thing that the controller does is to make sure that there is an active session for the user. If the session is active, the Controller will redirect the request represented by the click or the refresh to Generate and Display the Results (GDR) module 212. If the session is not active, the Controller will redirect the user to the Index/Login page.

GDR module 212 not only generates the results, but also displays them. It is implemented as a set of include files that must be included in all the pages that display results. GDR module 212 also verifies that the user making the request has access to all the assets by getting authorization from Authorization module 214. GDR module 212 uses the user credentials and asset id to query database 130 to get the information that can be displayed given the request and the assets to which the user making the request currently has access. On the very first entry into this system by a user during a session or on any subsequent click on the MyPlace link in the session, the GDR module 212 passes the user credentials to Authorization module 214 to determine all of the assets which the user either owns or to which the user has been given access by other users. In subsequent operations performed during the session, the GDR module 212 interacts with the Authorization module in a context-sensitive manner, by passing the user credentials and the ID for the asset involved in the operation. GDR module 212 will perform the operation and display the results in user home/asset display (UHAD) window 220 only if Authorization module 214 indicates that the user credentials are valid and that the user has the access to the asset that is required by the operation. Thus, what GDR module 212 causes to be displayed in UHAD window 220 is the workspace of the user to whom the session belongs.

In the current implementation, there are five kinds of access which a particular user may have to a particular asset: 1) Read, 2) Read and Write, 3) Read, Write and Delete, 4) Full, and 5) Remove. A user may have more than one of these kinds of access simultaneously. The first three kinds of access are self-explanatory. Full access allows the recipients to modify access to the asset as well as to read, write and delete. Remove access is used to remove a user or users' access to a particular asset. Since folders are assets, each level of the hierarchy of assets may have a different kind of access. However, unless the user specifying access rights gives another kind of access to a child node in the hierarchy, the child node inherits the access rights of its parent node. It is therefore not necessary for the user who is specifying access rights to explicitly specify access rights for all levels of the hierarchy.

Because asset rights may be inherited, Authorization module 214 has to search the hierarchy above the node representing the current asset for access rights. Thus, beginning at the current asset, Authorization module 214 first determines whether the user who needs access has been explicitly given access to the asset; if so, the explicit access determines what operations the user can perform on the current asset. If not, authorization module 214 examines the asset at the next higher node of the hierarchy in the same fashion; if the user has not been explicitly given access to that asset, module 214 examines the asset at the next higher node. This continues until authorization module 214 finds an asset at a higher node to which the user has been explicitly given access. Authorization module 214 then treats all of the nodes below the higher node to which the user has been explicitly given access as having the same kind of access that the user was explicitly given to the higher node. The hierarchy is searched even if the user is the owner of the asset. The reason for this is that the owner may want to provide him or herself with explicit access to the assets he or she owns which is less than the FULL access the owner has by virtue of being an owner in order to make sure that the owner does not accidentally modify or delete his or her own assets.

User Home/Asset Display (UHAD) window 220, of which screenshots are shown in FIGS. 11A and 11B, displays the user's workspace. UHAD window 220 is context sensitive, and its contents change based on the asset selected. FIG. 11A shows a screenshot of what the user sees when he or she logs into the system, or clicks on MyPlace. FIG. 11B shows a screenshot of what the user sees when the user selects any asset shown in window 220, for example MyFolders.

MyPlace, as shown in FIG. 11A (UHAD window 220), is the launching pad for accessing all assets accessible to the user. There are 5 major categories of assets in this implementation. They are 1) User Information, 2) MyFolders (Folder/Files), 3) MyGroups (User groups), 4) MyLists (To do Lists), and 5) MySchedules (Calendar/Appointments). A user who is the owner of any of these assets or has been given Full access by another user can permit other users to access the asset. Other embodiments may of course have additional kinds of assets. Each of the kinds of assets provided in the preferred embodiment will be discussed in detail below.

The window displayed on the browser by UHAD 220 contains 4 major sections in this implementation. They are: 1) Asset Navigation Pane 230, 2) Site Navigation Bar 240, 3) User/asset/Entity Results Pane 250, and 4) User/Asset/Entity Attributes Bar 260. The user can use any of these panes or bars to navigate throughout his workspace, and beyond onto the WWW. UHAD 220 thus provides a simple way for the user to view all of the assets to which he or she has access. In the preferred embodiment, the interface permits the user to drill down the levels of the hierarchies of the assets to which the user has access. Each of the 4 sections will be discussed in detail below.

As one can see from the flowchart in FIG. 2, the only way that the user can get UHAD 220, is by going through Controller 200 and GDR module 212, which in turn interacts with Authorization module 2146, thus ensuring that the information displayed by UHAD 220 is completely current with regard to the assets to which the user has access.

Asset Navigation Pane (ANP) 230, which is part of UHAD window 220 (FIG. 11A), is the primary means of navigation among the assets to which the user has access. The user can user ANP 230 to drill down the hierarchy of assets to which he has access to view/access the information contained in any of those assets. At the top level, the hierarchy of assets appears to the user as a forest of trees: one tree, indicated by MyFolders, is the hierarchy of assets of which User Z is the owner; other trees, indicated by the user names in SharedFolders are for assets which other users have shared with the user who is interacting with ANP 230. ANP 230 is context sensitive, and will change depending on the asset selected by the user. For example, clicking on MyFolders 232 will display the assets which are children of the top level of the tree to which the assets owned by user Z belong. From here, the user can drill down that hierarchy of assets or move back up that hierarchy. Similarly, clicking on User X in Shared Folders will display the assets which are children of the top level of the tree of the assets which user X has shared with user Z. Clicking on MyFolders 232 further changes what is displayed in the User/Asset/Entity Results Pane (UAERP) 250, which will be discussed further on down.

In addition, the user is able to visually recognize changes in his/her shared assets 234. In the preferred embodiment, the names of shared assets in which changes have occurred are highlighted in RED. Also highlighted in RED is the path through the tree containing the changed shared assets from the root of the tree in Shared Folders to the shared asset in which the change occurred. The asset and the path remain highlighted until the user has seen the change, i.e. selected the asset that has changed; at that point the path reverts to its normal color, which is blue.

Site Navigation Bar (SNB) 240, which is part of UHAD window 220 (FIG. 11A), is the primary means of navigation in system 101, and is available from anywhere in the GUI. SNB consists of links to Home page 242, Feedback 244, Help 246 and Logout 248. The Home Page and the Feedback links are context sensitive. Originally, they point to the user's MyPlace window, but when the currently-selected asset is a shared asset, the Home Page link points to the home page for the owner of the shared asset and clicking on the Feedback link permits the user to write an email message to the asset's owner; system 101 then sends the message to the owner. FIG. 11B show the links to User Z's home page on system 101 and to feedback for user Z. The Help link takes the user to the help files for system 101. Clicking on Logout 248 calls End Session module 249 to close out the open files and end the user session.

User/Asset/Entity Results Pane (UAERP) 250, which is part of UHAD window 220 (FIG. 11A), is a context-sensitive subwindow in which the results of the selection made on APN 230 are displayed. The contents of this subwindow vary depending on the asset selected under APN 230. For example, as shown in FIG. 11B, when MyFolder or any subsequent Folder asset is selected, the results will be a list of the contents of the folder asset. These results are displayed in a table format, with columns and rows. Typically these columns contain check boxes, Thumbnails, File descriptions, File name, Date, Owner, Size of file, etc. Each of the rows contains information about one asset. The Check boxes are used to select the files by calling Select entity module 252, which in turn creates a list of assets that are selected. The list is used by Modify Entity Attributes 266. Clicking on the column headers will call the Sort Results module 254, which will sort this table based on the selected column.

User/Asset/Entity Attributes (UAEA) Bar 260, which is part of UHAD window 220 (FIGS. 11A and 11B), is employed by the user of the GUI to access the modifiable attributes of the assets selected by 232, 234, or 252. The bar typically contains dropdown menus for Assets 264, Entities 266, and Context sensitive Help files 262. The dropdown menus are context sensitive, meaning that GDR 212 will only display the operations that the user's kind of access to the asset permits the user to perform on the asset. The default asset for the UHAD window is User Information. User Information assets contain user specific information and this fact is reflected by the dropdown menus for the asset: Thus, when the asset is a User Information asset, UAEA bar 260 has the following dropdown menus: User Account, User Profile, and User Network Information. However, for most other assets, UAEA bar 260 contains Asset Attributes 264 and Entity attributes 266. These are discussed in more detail later on. The Help link 262 is a context sensitive drop down menu, which will provide links to the Help files that are appropriate to assets and entities based on the current selection.

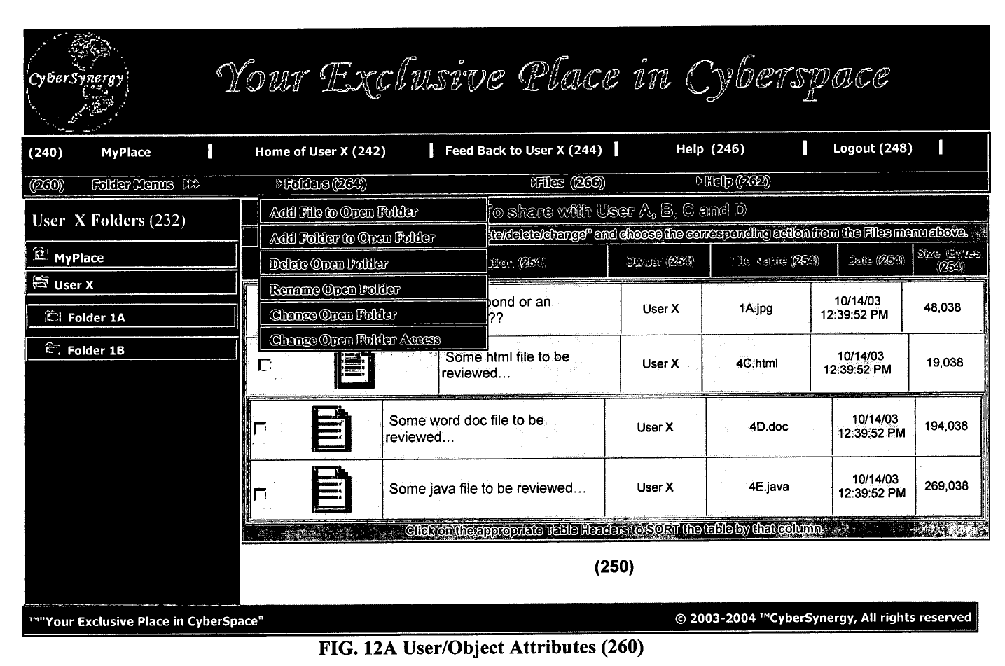

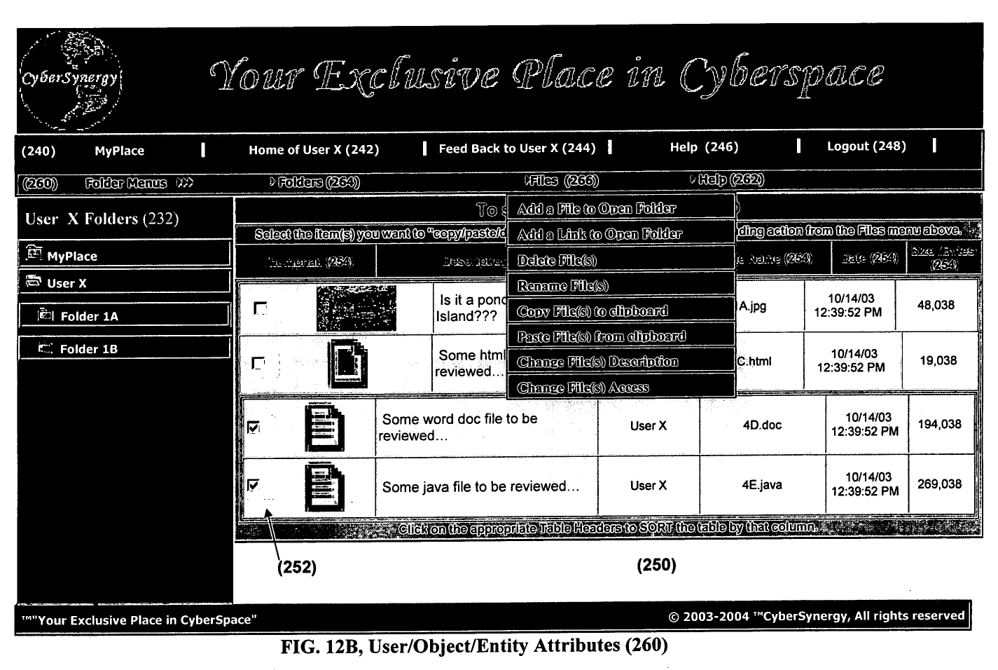

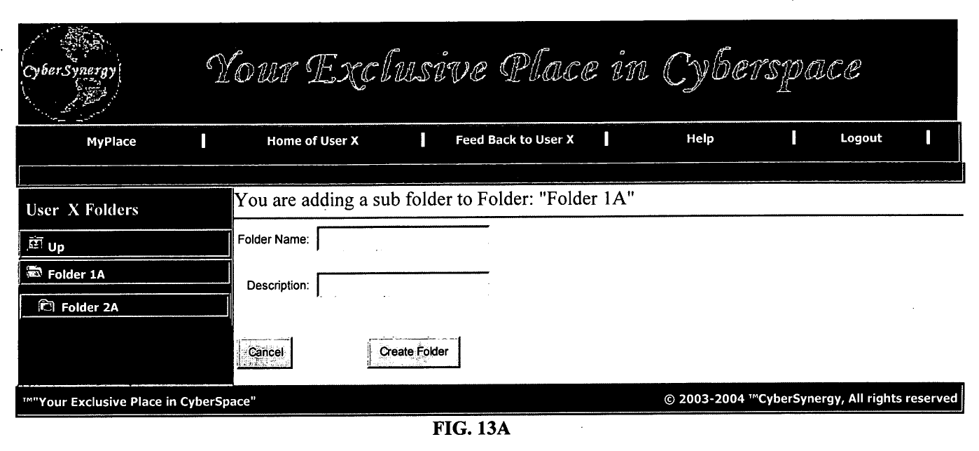

Modify User/Asset Attributes dropdown menu 264, as shown in FIG. 12A, provides the user with a choice of operations that the user's kind of access permits on the asset. For example, if the asset is a Folder, and the user has FULL access, the following functions are available in this implementation:
Add a File to selected Folder: This function allows the user to upload a file that will be automatically inserted into the selected folder. The file will automatically inherit all the access rights of the parent folder. Any user who has access to the parent Folder will also be able to access the uploaded file.
Add a Folder to selected Folder: This function allows the user to create a sub-folder that will be automatically inserted into the selected folder, which can eventually lead to folder tree hierarchy. Like the uploaded file, the new folder will automatically inherit all the access rights of the parent folder.
Delete selected Folder: This function allows the user to delete the selected folder.
Rename selected Folder: This function allows the user to rename the selected folder.
Change selected Folder description: This function allows the user to modify the description associated with the selected folder.
Change Access to selected Folder: This function allows the user to change access rights to the selected folder. More details on this later on.

The operations seen by users with other than FULL access depend on the kind of access they have.

The changes resulting from these operations are instantly reflected in the GUIs for users currently having sessions with system 101. All operations except Delete will further cause the folder's name to be highlighted as unseen in the GUIs for users that have access to the folder but have not yet seen the folder as changed by the operation.

Modify Entity Attributes dropdown menu 266, as shown in FIG. 12B, provides the user with a choice of operations that can be performed on the files contained in an open folder. The following operations are available in this implementation:
Add a File to selected Folder: This function allows the user to upload a file that will be automatically inserted into the selected folder. Again, the file will automatically inherit the parent folder's access rights.
Copy File(s) to Clipboard: This function allows the user to copy all the selected files (via checkbox) to a buffer, which will be used by the Paste function.
Paste File(s) from Clipboard: This function allows the user to paste or insert all the selected files (via checkbox) to the selected Folder.
Delete selected File(s): This function allows the user to delete all the selected files (via checkbox) from the system 101.
Rename selected File: This function allows the user to rename the selected file.
Change selected File(s) description: This function allows the user to modify the description associated with the selected files (via checkbox).
Change Access to selected File(s): This function allows the user to change access rights to the selected file(s). FULL access is required for this operation.

Which of these operations a given user sees depends of course on the kind of access the given user has to the file. As with folders, changes that result from all the above functions are reflected instantaneously in the GUIs of users currently having sessions with system 101. Also as with folders, all operations except Delete will further cause the file's name to be highlighted as unseen in the GUIs for users that have access to the file but have not yet seen the changes.

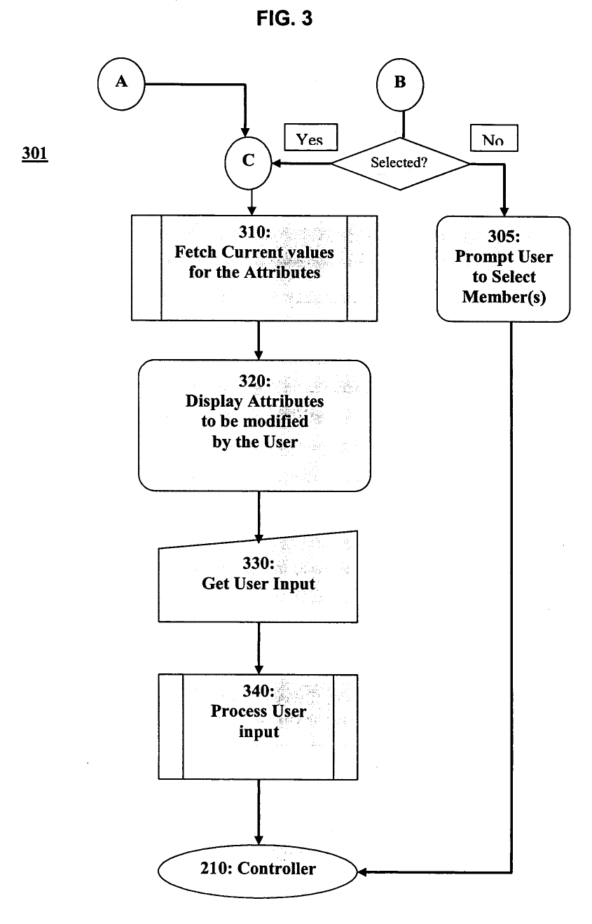

Functional Overview of Attribute Modifications: FIG. 3

FIG. 3 is a flowchart 301 which shows how a user with the required access can modify the attributes of an asset. Screenshots shown in FIGS. 12A and 12B show the GUI for the interaction. If the user selects dropdown menu 264 (FIG. 12A) and chooses an attribute to modify, that attribute will be modified in the open/selected asset from those displayed by modules 232 or 234. However, it must be noted that the user must select files 252 from the results pane 250 (by clicking on check boxes, FIG. 12B) first, before the user can select from the dropdown menu 266 (FIG. 12B). If there are no files selected, the user will be warned 305, and then redirected to the UHAD window.

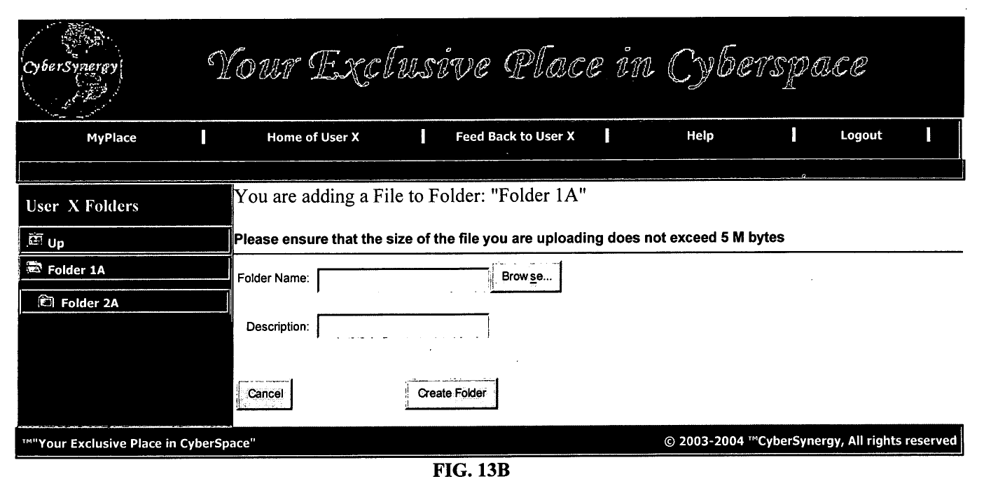

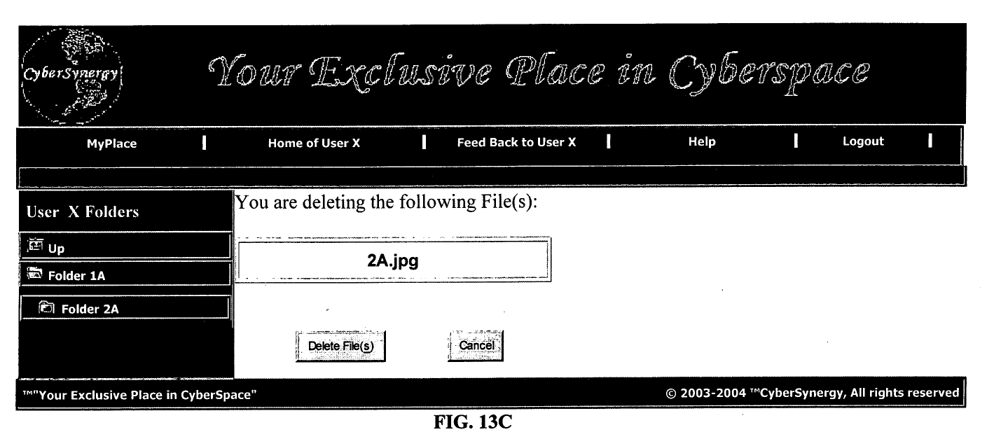

Once the user has successfully selected an operation, system 101 will first fetch current values for the appropriate attribute 310. For example, FIG. 13A shows a screenshot for the GUI that appears when the user has selected adding a folder to an open folder in dropdown menu 264, FIG. 13B shows a screenshot for the GUI that appears when the user has selected adding a file to an open folder in drop-down menu 266, and FIG. 13C shows a screenshot for the GUI that appears when the user has selected deleting a file in drop-down menu 266. These screens display the current attributes for the asset whose attributes are being modified and have fields for receiving user input 330 for the operation. Once the user provides the input and clicks on the button that requests the system to perform the operation, system 101 modifies database 130 so that the asset has the new attribute values. Thereupon, system 101 hands over control of the session to Controller 210, which in turn redisplays User Home window 220.

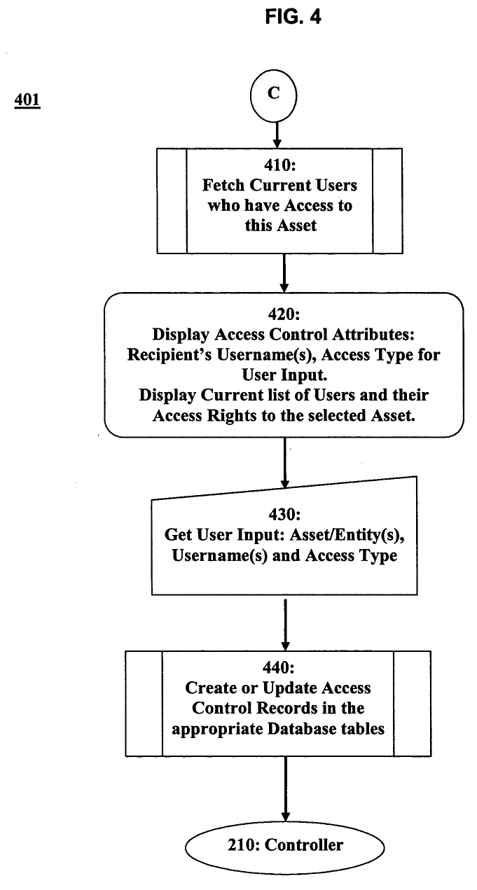

Functional Overview of Access Control Attribute Modifications: FIG. 4

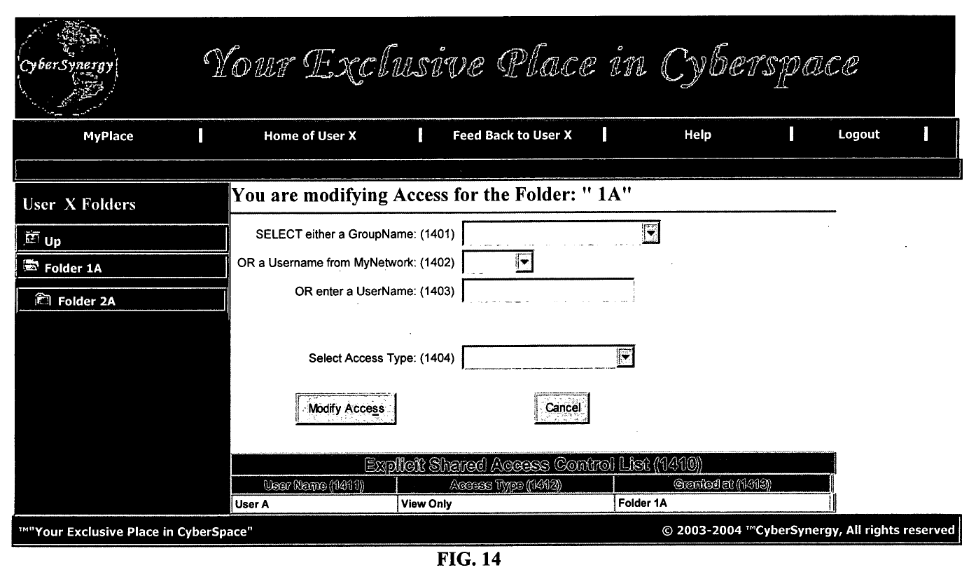

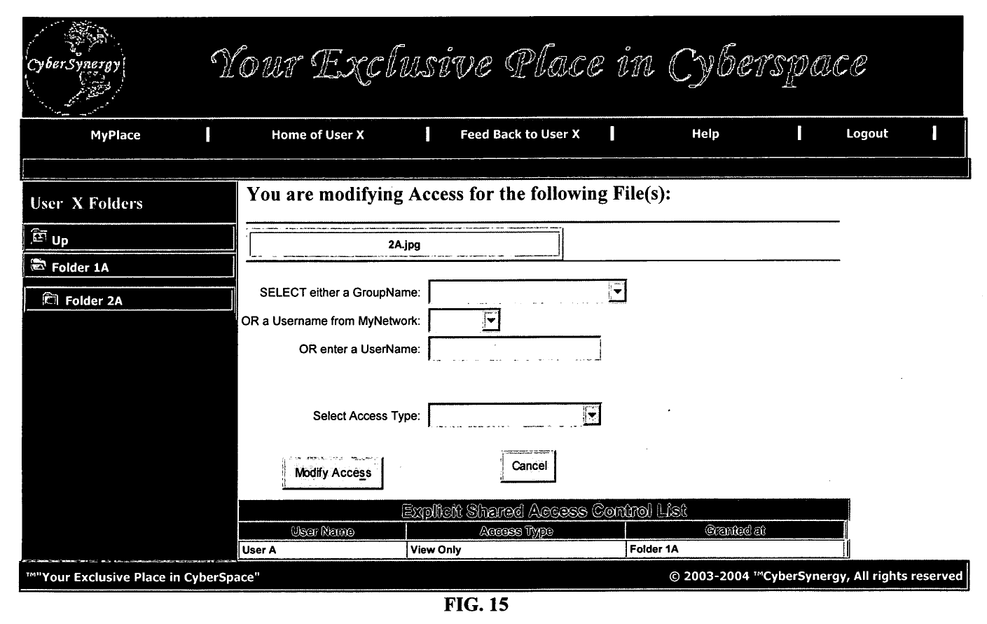

FIG. 4 is a flowchart 401 which shows how a user who has FULL access to an asset interacts with system 101 to explicitly specify the kind of access that another user will have to the asset. This is done using Object Attributes 264 or Entity Attributes 266. Entities here are assets which have been uploaded to system 101 by users. The user interface for such modifications is shown in FIGS. 14 and 15. When the user selects Change Access from the dropdown menus 264 and 266 shown in FIGS. 12A and 12B, the user is redirected to an Access Control window 420, shown in FIG. 14. Of course, if the user does not have FULL access to the asset for which access is being changed, Change Access will not appear in the drop down menus in the user's GUI.

Once the user has successfully selected the Access Modification operation, the system will first fetch the user ids for the users who have access to the asset for which access is to be modified and the current kind of access which each of the users has, as shown at 410. Note all that system 101 needs to know to fetch the user ids is the current user id and the id of the asset whose attributes are to be changed. Next Display Access Control window 420 (FIGS. 14 and 15) displays the list of users who have been explicitly given access to the asset and their kinds of access in the Explicit shared access control list at the bottom of FIG. 14 together with fields for receiving the input in the middle of the screen. These fields are 1) Group Name, 2) Username from MyNetwork, 3) Username, and 4) Access Type. The group names are selected from a dropdown menu of group names for group objects belonging to the user; the usernames from the user's MyNetwork group appear in a dropdown menu, and the user can enter an arbitrary username in the third field. The access type is input using a drop-down menu in the fourth field; buttons just above the Explicit shared access control list permit the user to modify access as specified in the input fields or cancel the operation. The access type drop-down menu includes Remove, which is not an access type, but specifies that any explicitly-given access for the specified user or group of users to the asset be revoked. The preferred embodiment presently has no mechanism for revoking inherited access to an asset. All that would be required to do this would be to add “No Access” to the list of kinds of access which a user may be explicitly given to an asset.

GroupName is the name of a group object. A group object is an object that contains a list of usernames. Owners of assets on system 101 can create group objects and users with FULL Access to a group object can create, modify and delete the group object. Any user with FULL access to a group object can add any usernames valid in system 101 to the list or delete a username from the list. A group may be specified when access to an asset is modified, and when that is done, the specified access is given to every user specified in the group. Similarly, a group may be specified in a message and the message will be sent to all of the users in the group.

MyNetwork 1402 is a special case of Group. MyNetwork is a list of usernames of users of system 101 that the user to whom MyNetwork 1402 belongs has signed up as his network. Whenever a user uses MyNetwork dropdown menu (FIG. 11A, MyNetwork Menus 260) to signup a user, system 101 will automatically add that username to the user's MyNetwork list. The owner of a MyNetwork group object has only read access to the object.

The Explicit Shared Access Control List of the users that have been explicitly given access to the asset for which access is to be changed is displayed in a table format. The table contains 1) the username of the user to whom the access represented by the entry has been given, 2) the access type 3) At what point in the asset's hierarchy the access was given. You can only modify the access rights to the selected asset at 232 or 234 of flowchart 201.

Once the user provides the input and clicks on the modify access button, the access for the asset is updated as indicated by the user inputs (block 440), resulting in a modification or creation of user/asset access relationships in data storage 130. Finally, system 101 returns the user's session to Controller 210, which in turn will redisplay User Home window 220.

Problems of Asset Sharing

Sharing assets among users have traditionally been seen as a matter of relationships between the shared asset(s) and the user(s) with whom they are shared. Typically either the owner of the asset or an administrator of the asset shares an asset with a user by granting access to the asset to the users who are to share it. Deployments of system 101 may have millions of users, with billions of assets. With numbers of users and assets on this order, it is a challenge to find techniques which enable a particular user to quickly see all of the assets that the user has access to. To make it possible for the user to see all of his assets, we must solve the following problems:
Determining which User has Access to Which Shared Asset(s).
Keeping track of which User has seen a Shared Asset(s).
Keeping keep track of each user's path to a shared asset which the user has not yet seen.

Moreover, these problems must be solved in a fashion such that determinations of access relationships between users and assets may be made quickly enough to be usable in an interactive system and such that the space required to represent the access relations remains relatively small. We further discuss these problems below:

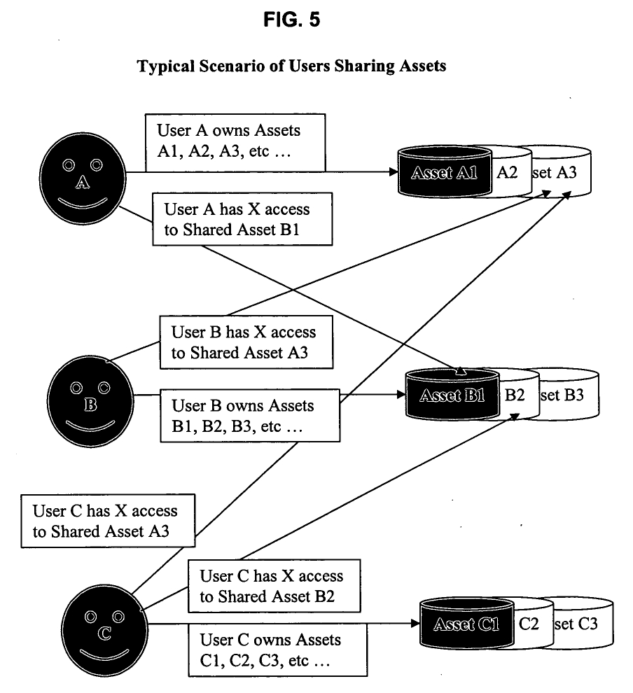

Typical Scenario of Users Sharing Assets: FIG. 5

FIG. 5 depicts a typical scenario of users sharing assets. User A owns the assets A1, A2 and A3, and has shared access to asset B1. Similarly User B owns assets B1, B2 and B3, and has shared access to asset A3. Also, user C owns assets C1, C2 and C3, and has shared access to A3 and B2.

Which User has Access to Which Shared Asset(s)?

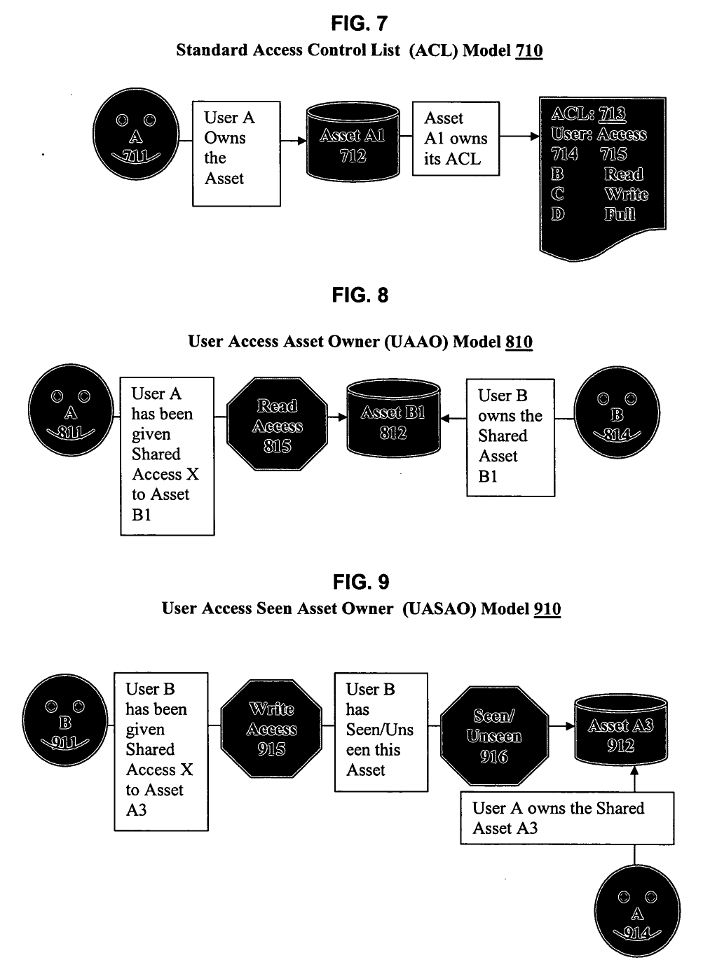

To implement a system that will allow the users to share assets as shown in FIG. 5, we need to first find an Access Control Model that will not only answer the question “Which User has Access to Which Asset(s)?”, but will do so in a space- and time-efficient manner. If you want to figure out “who are all the users that have access to a specific asset”, then the standard ACL model 710 shown in FIG. 7, is perfectly suited. However, if you want to figure out “which user has access to which assets” the standard ACL model becomes impractical. To find the answer using the ACL model, you have to look at the ACL for each and every asset in the system 101. The time required to figure out which user has access to what assets grows geometrically with the number of assets and users. For interactive systems such as system 101, which redetermines asset rights every time an event involving asset rights occurs, the delays involved in figuring out access using ACLs are completely unacceptable.

Keeping Track of which User has Seen a Shared Asset

The next problem associated with assets in system 101 is keeping track of who has seen which shared asset? Since system 101 makes shared assets available to a user without any action on the user's part, we need a way to point out to the user that there is an asset available to the user that the user has not yet seen.

Keeping Track of the Path to an Asset in which a Change has Occurred Until the User Sees the Change

The next problem associated with shared assets is how to guide the user using the GUI to a shared asset which has changed but which the user has not yet examined and which may be buried deep in the hierarchy of the assets shared with the that user by another user. It should further be remembered here that the tree of shared assets that the GUI's user sees is specific to that user. What is needed is a way of keeping track of the path to an unseen asset through the tree particular to that user. The solution is “transient” path information, which can be discarded as soon as the user has seen the asset.

System 101's Access Control Model

System 101's Access Control Model solves all the above problems. It permits system 101 to figure out all the shared assets that belong to a user and does so in near real time using compact data structures. Thus, system 101's GUI permits the user of the GUI to jump from assets shared by one user with the GUI's user to assets shared by another user with the GUI's user. The Access Control model further determines whether there are any shared assets which the GUI user has not yet seen and provides the information necessary for the GUI to indicate to the user that there are unseen assets and to guide the user to the unseen assets.

Standard Access Control List Model 710: FIG. 7

In order to provide background for the following discussion, FIG. 7 shows an Access Control List (ACL) 710. The ACL is an industry standard access control model used in many file management systems. The relationship information of “who 714 has access 715 to what 712” is tightly coupled with the asset in the form of an access control list 713 that is associated with each asset. ACLs are typically text files that show which users have what type of access. Typical ACLs are a simple table with 2 columns, containing user id 714 and access type 715. Note these lists do not contain any information about the asset itself. These ACLs are owned by the asset with which they are associated. The asset in turn has an owner 711. To get to an ACL, one needs to go via the owner who owns the asset and the asset that owns that ACL.

User Access Asset Owner (UAAO) Model 810: FIG. 8

To be able to quickly determine which user has access to which assets, we use a unique relationship model, called a User Access Asset Owner model 810, as shown in FIG. 8.

The Access Control Model used in system 101 can be implemented as a single relationship table for the entire system. The basic concept is: there are users, and there are assets and there are different types of access to the different shared assets. By creating a single relationship model 810, as shown in FIG. 8, between all the users and all the assets and the access type, we can keep track of what user has what access to any shared asset. The relationship table can be used to quickly find what assets a particular user has access to.

User Access Asset Owner model 810, shown in FIG. 8, contains the following 4 items:
what Asset? 812 (unique Asset Id)
belonging to Whom? 811 (unique asset Owner Id),
is shared with Whom? 814 (unique recipient's User Id)
with the Access Type 815 (Access Type: Read, Read+Write, Read+Write+Delete, Full, Remove and Transient).

The first 3 fields, Asset Id, Owner Id and User Id, are fairly straightforward in their semantics and as such the usage is “what Asset Id belonging to Owner Id has Owner ID permitted to be shared with User Id”. However, the usage of the fourth field, Access Type 815, has been extended from the traditional kinds of access (Read, Read+Write, Read+Write+Delete, Full) to include Remove and Transient access. Transient access to an asset is automatically given to a user by system 101 and serves to permit users who have access to assets lower down in the hierarchy to traverse the hierarchy and to implement notifying the user that there is an asset that the user has not yet seen. Access Type “Remove” is actually an operation which may be performed by a user with FULL access. Its effect is to remove the relationship between the owner, user, and asset from the table.

A problem with model 810 is that a table that contains an entry for every user for every asset that the user has access to quickly becomes very large. In system 101, inherited access is used to reduce the size of the table. Because there is an entry in the table for the asset the access is inherited from, there is no need for entries in the table for the assets that inherit the access. Thus, in system 101, model 801's table contains an entry for an asset only if a user has been explicitly given access to the entry.

Transient Access

When the kind of access 815 is “Transient”, the user has access to an asset for the purpose of traversing the tree structure only. When a user with FULL access shares an asset with another user, System 101 adds the transient access type to nodes in the asset owner's asset hierarchy as required for the sharing user to reach the shared asset. Thus, when a user is given access to a branch of tree, a Transient access type for that user is assigned by the system to all the nodes between the branch and the root node of the tree. This enables the system to do 2 things:
1) Uniquely identify the path for a specific user through the owner's asset hierarchy to a specific asset. Once the path is identified, it can be highlighted in the GUI; and
2) Navigate through the Owner's asset tree when the user has access only to assets at nodes which are at the 2^{nd} or 3^{rd} level from the root node.

Please see the implementation part for more details.

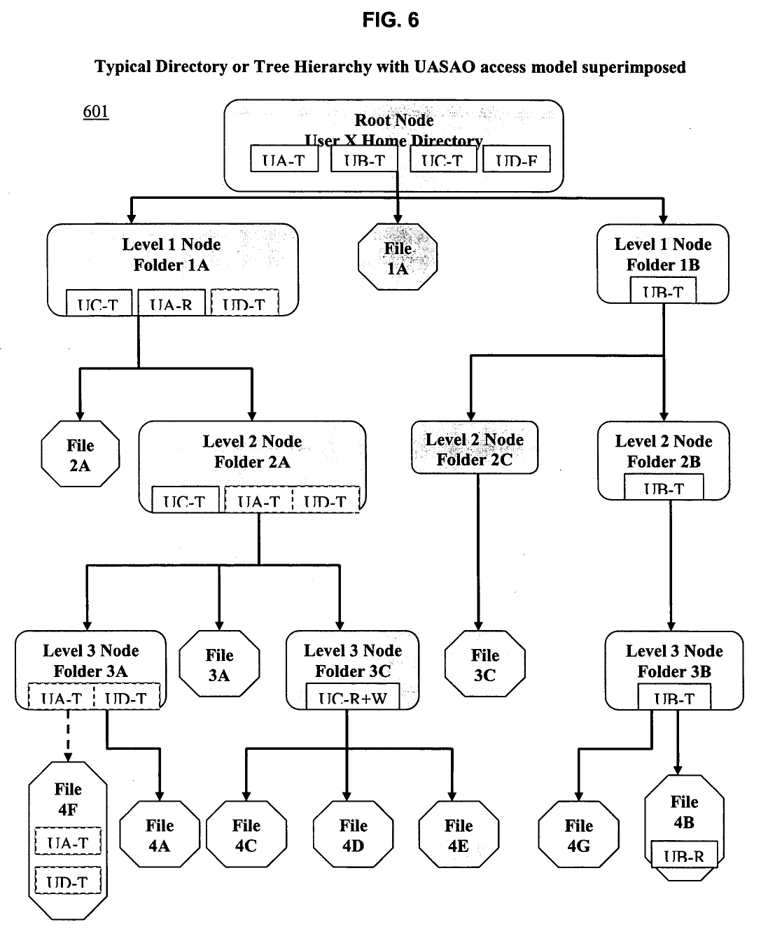

Description of Transient Access: FIG. 6

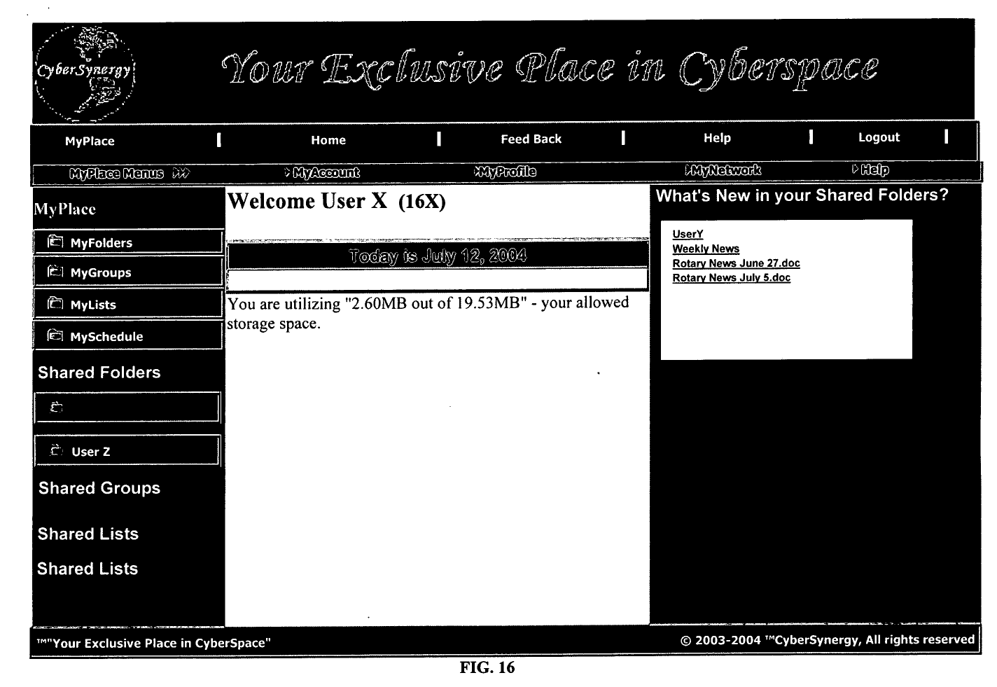

FIG. 6 shows a typical directory tree hierarchy superposed with the UASAO tags. FIGS. 16-37 are a series of screen shots of MyPlace, MyFolder and Shared Folder drilldown views. The screen shots show different users' views of the tree of assets belonging to User X. Each of these figures has a label of the form 16<x>-<xx>. The first letter <x> after 16 in these labels stands for one of users (X, A, B, C or D). The 2 letters <xx> stand for Folder Tree level and Names: 0 for root node, 1A for level 1 Folder A, 1B for level 2 Folder B, etc.

We will discuss 4 cases in which the users (A, B, C and D) have been given shared access to assets in User X's tree of assets. We will take each case, and explain how the Transient access type is used in identifying unique paths through User X's tree of assets for each of the shared users.

Case 0: User X's View of User X's Asset Tree

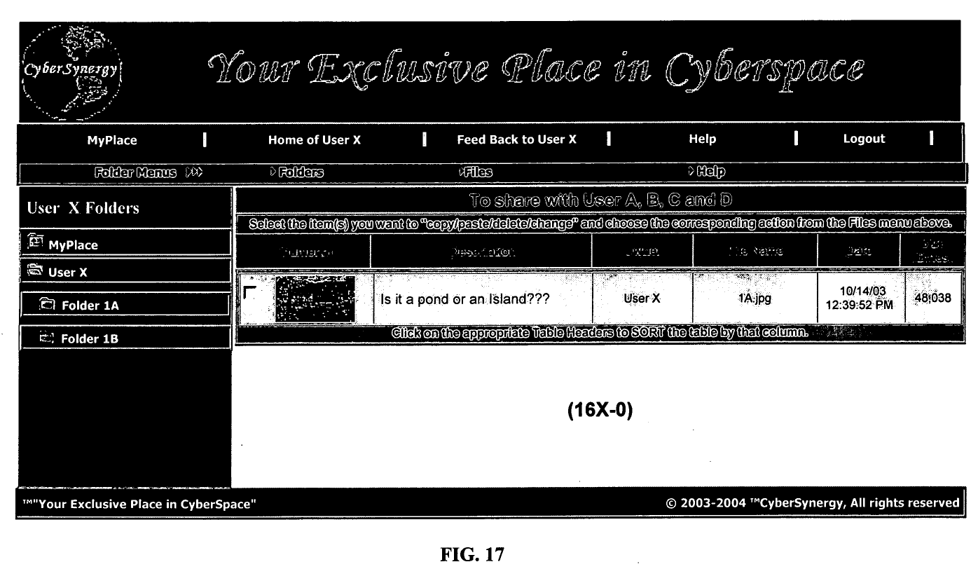

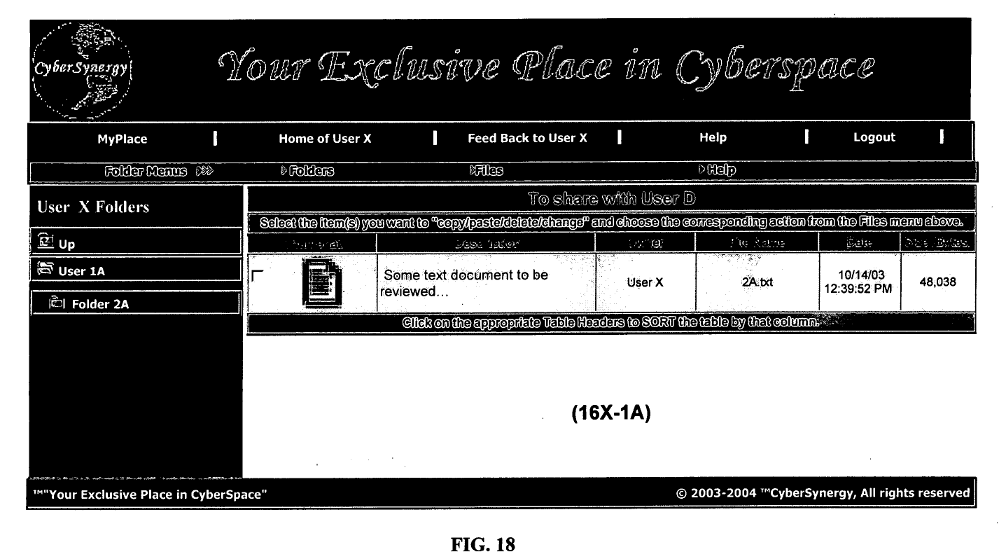

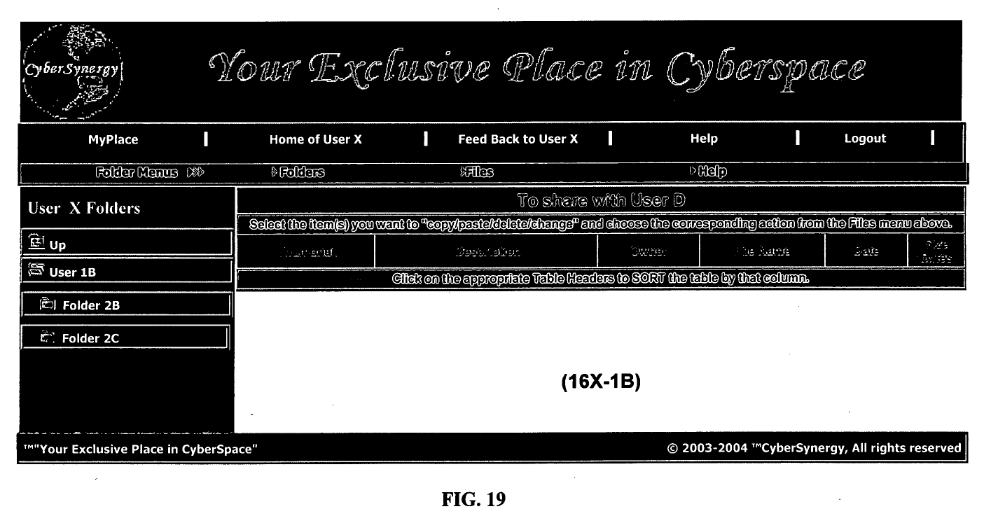

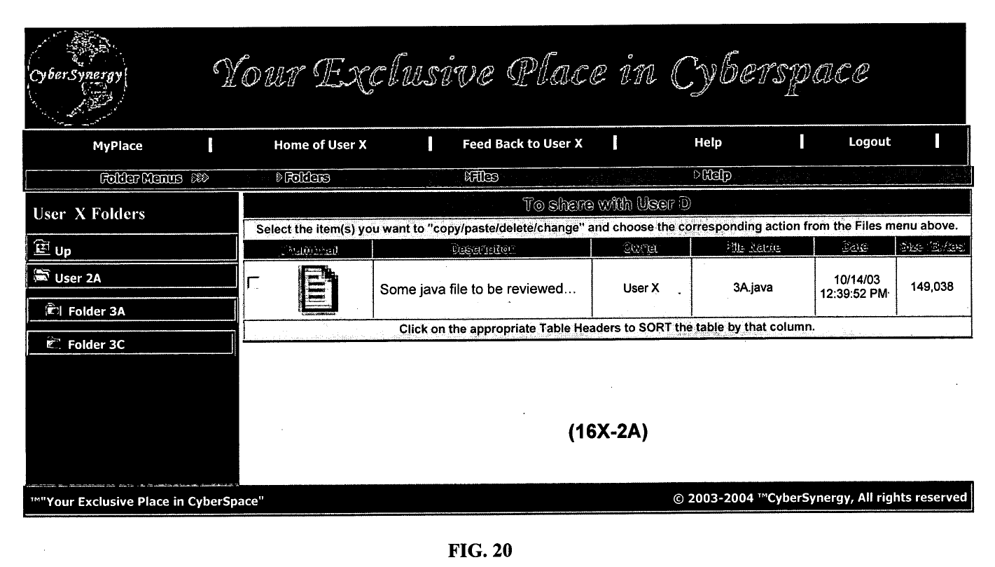

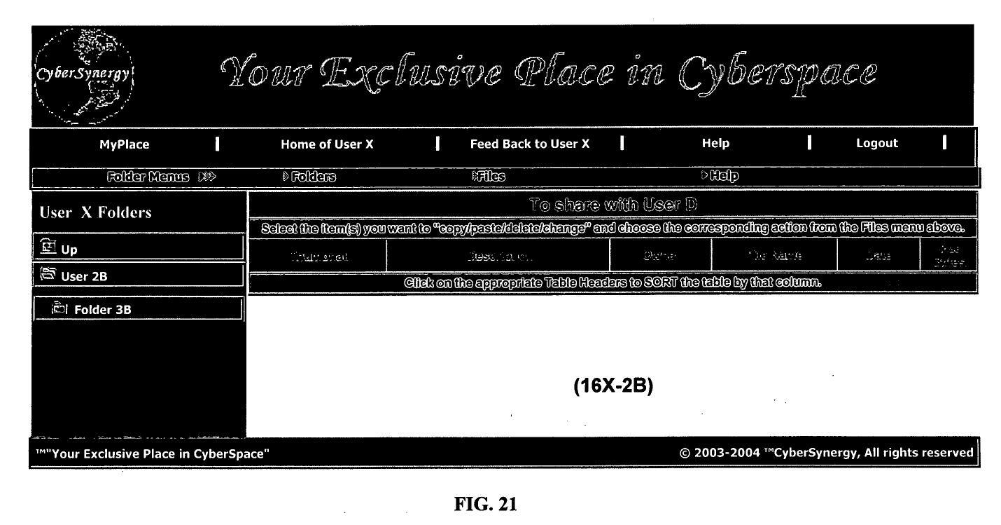

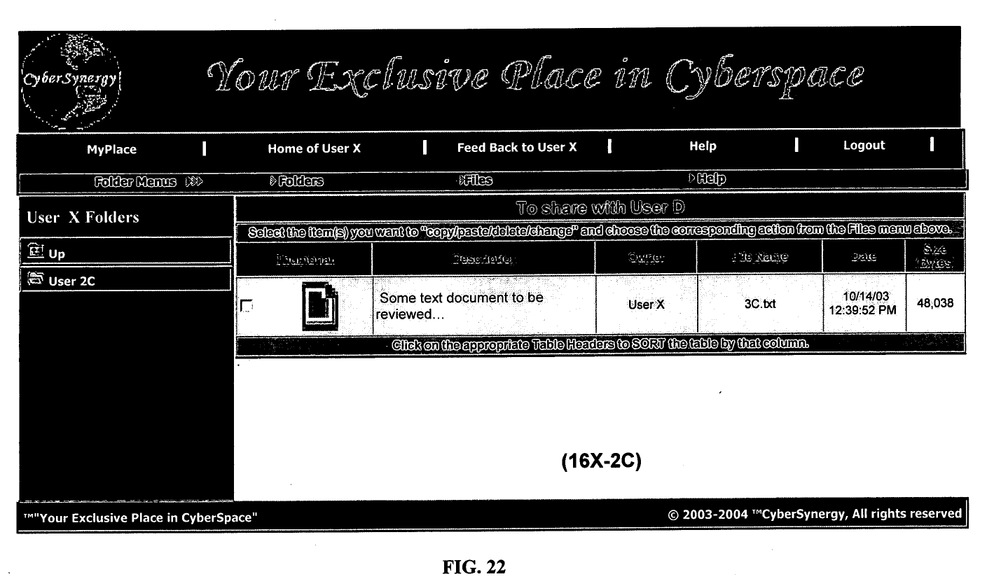

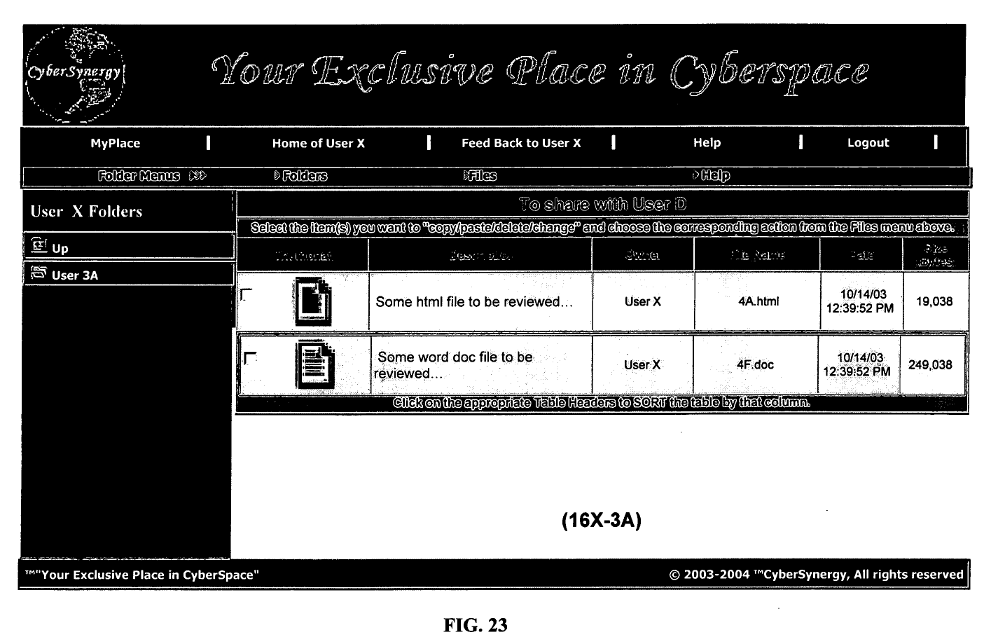

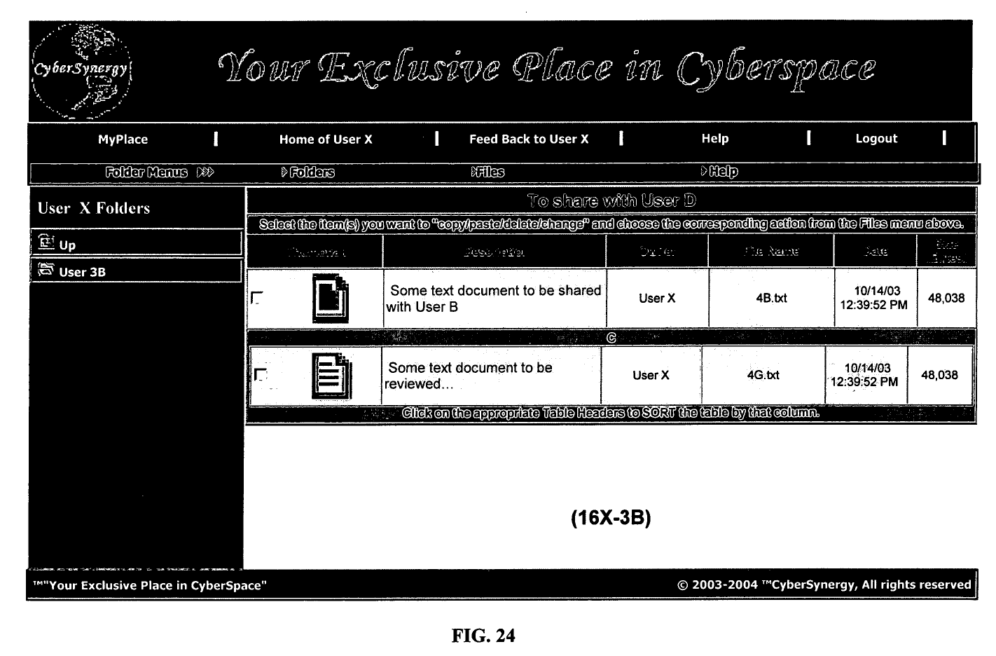

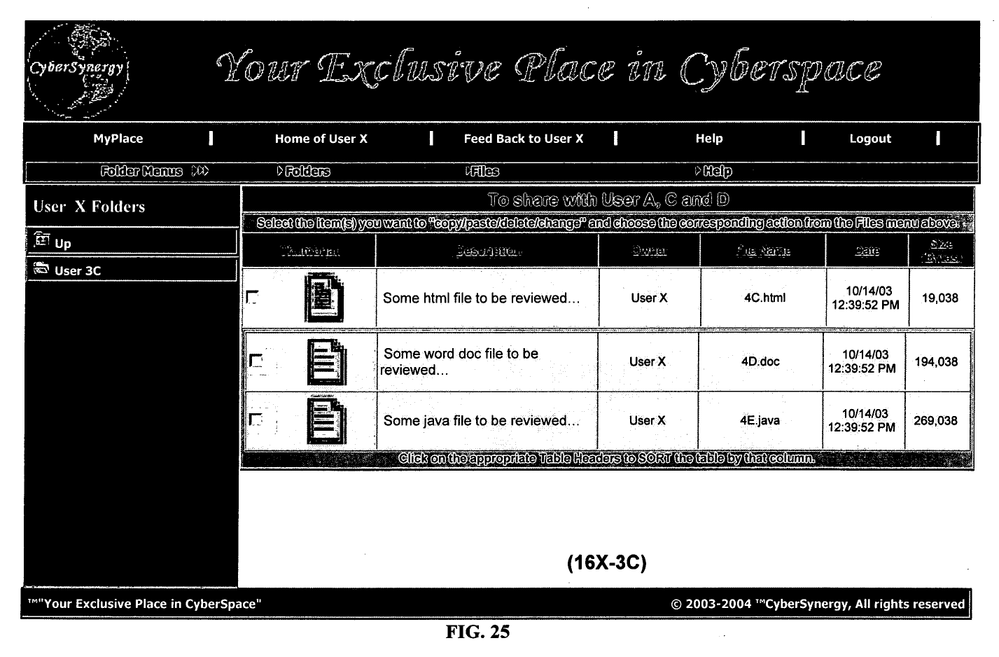

First let us consider the case of User X. The screenshots with the label 16X-<xx> shows various views as seen by user X.
FIG. 16 (16X) shows the MyPlace view for User X right after login or any time User X has clicked the MyPlace button.
FIG. 17 (16X-0) shows MyFolder view for User X when User X has clicked the MyFolder button.
FIG. 18 (16X-1A) shows Folder 1A view for User X when User X has clicked Folder 1A in FIG. 17 (16X-0).
FIG. 20 (16X-2A) shows Folder 2A view for User X when User X has clicked Folder 2A in FIG. 18 (16X-1A).
FIG. 23 (16X-3A) shows Folder 3A view for User X when User X has clicked Folder 3A in FIG. 20 (16X-2A).
FIG. 25 (16X-3C) shows Folder 3C view for User X when User X has clicked Folder 3C in FIG. 20(16X-2A).
FIG. 19 (16X-1B) shows Folder 1B view for User X when User X has clicked Folder 1B in FIG. 17 (16X-0).
FIG. 21 (16X-2B) shows Folder 2B view for User X when User X has clicked Folder 2B in FIG. 19 (16X-1B).
FIG. 24 (16X-3B) shows Folder 3B view for User X when User X has clicked Folder 3B in FIG. 21 (16X-2B).
FIG. 22 (16X-2C) shows Folder 2C view for User X when User X has clicked Folder 2C in FIG. 19 (16X-1B).
   Case 1: User A has READ Access to User X's Shared Folder 1A

Let us consider an example of User A having a READ access to User X's asset Folder 1A. The series of screenshots labeled 16A-xx shows various views as seen by User A.

When User A is granted access to Folder 11A, the system automatically adds Transient access UA-T to the root node of User X's asset hierarchy.
This will enable the system to display the root node of User X's asset tree as a shared node in the screen of FIG. 22A for user A.
All the folder and files under Folder 1A (File 2A, Folder 2A, Folder 3A, File 3A, Folder 3C, File 4A, File 4C, File 4D and File 4E) will also be accessible by the User A.
When the File 4F is added to Folder 3A by user X, User A will automatically share access to this file and will see it in User A's view of User X's asset hierarchy.
To make this happen, the system has to create Transient Access for User A to Nodes 3A and 2A.

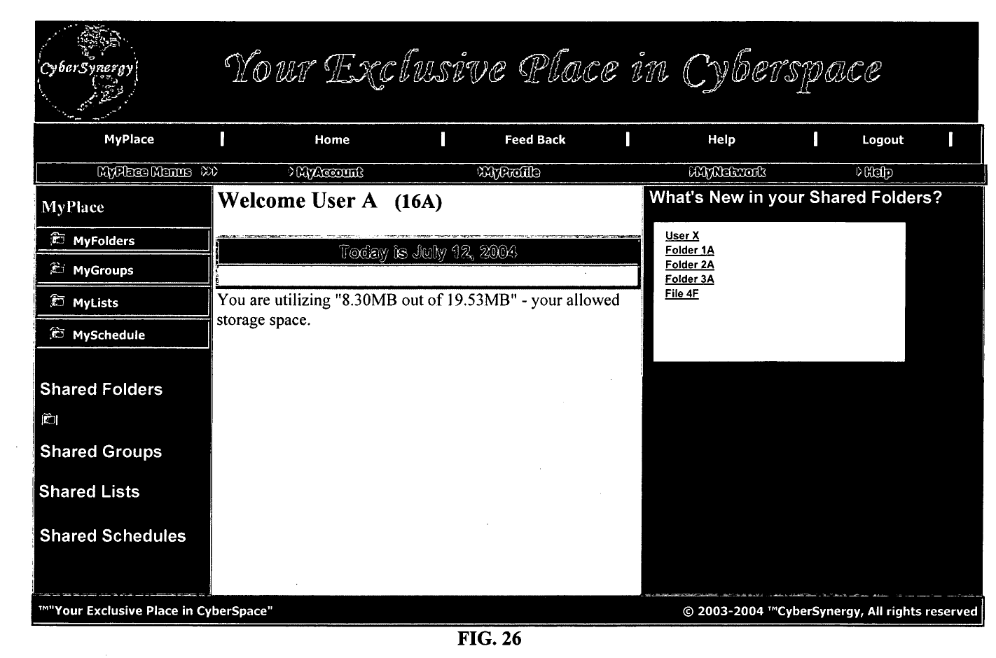

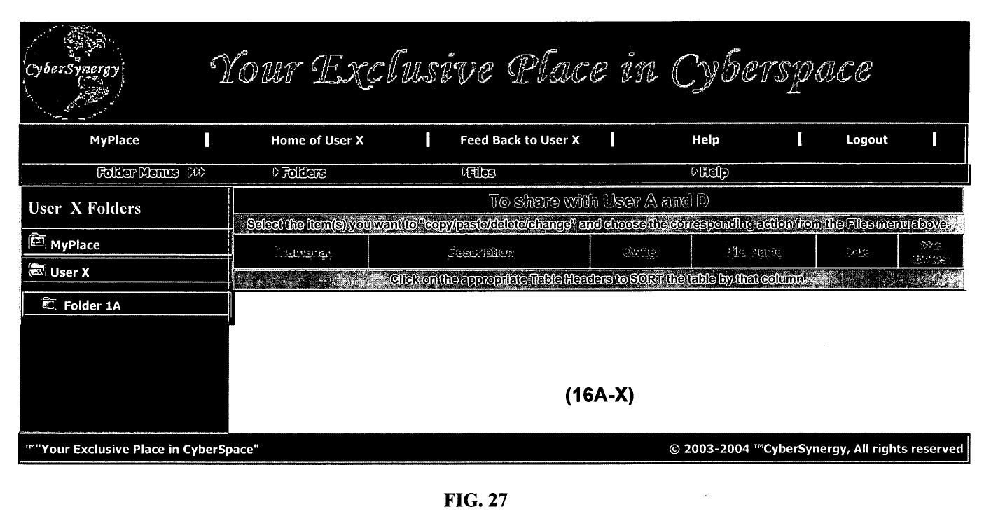

When User A logs into his system, he or she will see
User X under Shared Folders, as shown in FIG. 26 (16A).
When User A has clicked on User X, all User A will see is Folder1A, as shown in FIG. 27 (16A-X).
When User A has clicked on Folder 1A, User A will see File 2A and Folder 2A, as shown in FIG. 18 (16X-1A)
When User A has clicked on Folder 2A, User A will see Folder 3A, File 3A and Folder 3C, as shown in FIG. 20 (16X-2A)
When User A has clicked on Folder 3A, User A will see File 4A, as shown in FIG. 23 (16X-3A)
Note the user will only see File 4F after it has been added.
When User A has clicked on Folder 3C, User A will be able to see File 4C, File 4D and File 4E, as shown in FIG. 25 (16X-3C)

Since the Dropdown Menus are Access (READ) context sensitive, the User A will also see:
Nothing under dropdown menu 264 for Folders
Only Copy File from the File menu under dropdown menu 266 for files.
   Case 2: User B has READ Access to User X's Shared File 4B

Let us consider an example in which User B has been given READ access to shared asset File 4B, belonging to User X. The series of screenshots FIGS. 16B-xx shows various views as seen by user B.

When User B is granted access to File 4B, system 101 automatically adds a Transient access UB-T for user B to the root node of User X, Folder 1B, Folder 2B, and Folder 3B The transient access permits system 101:
To display the root node of User X to User B as a shared node.
To guide user B through User B's view of User X's asset hierarchy to File 4B.

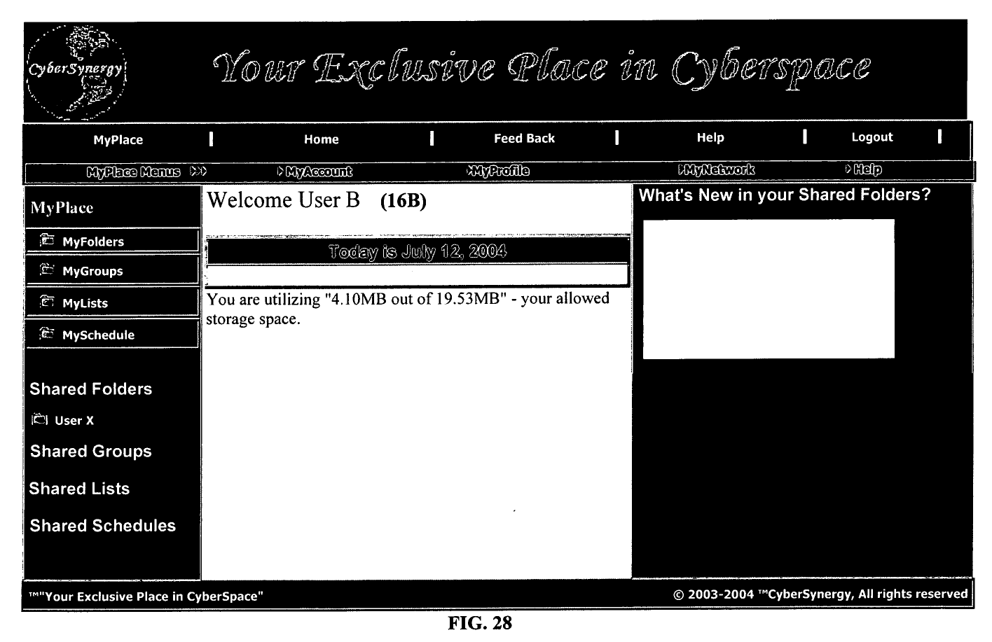

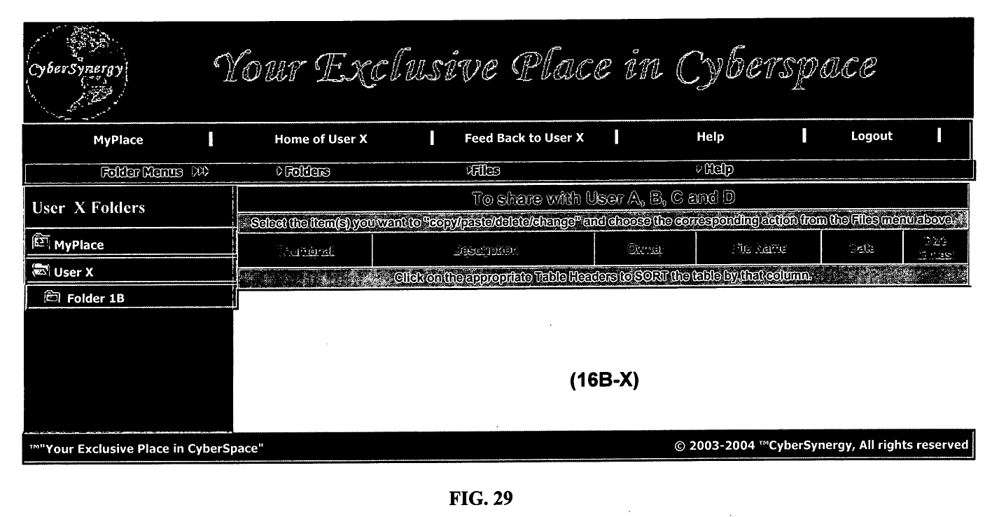

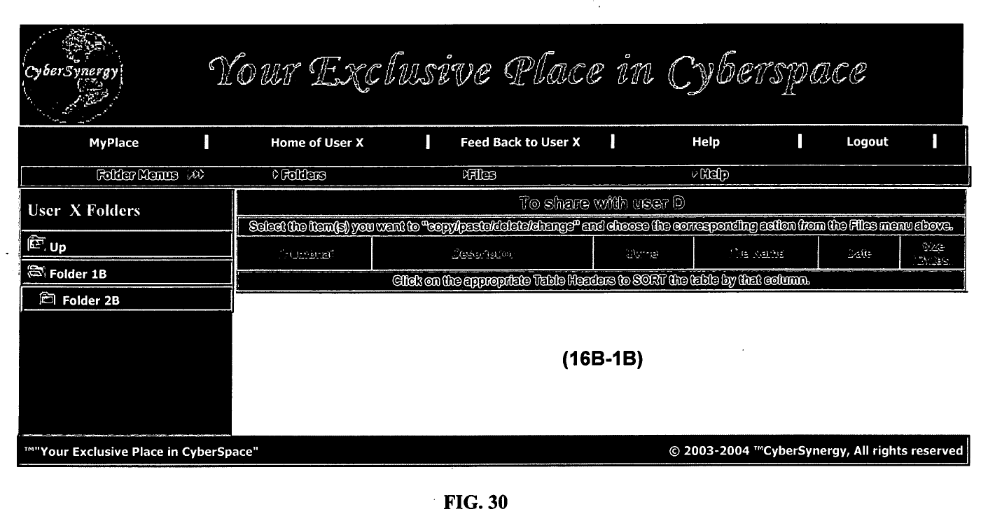

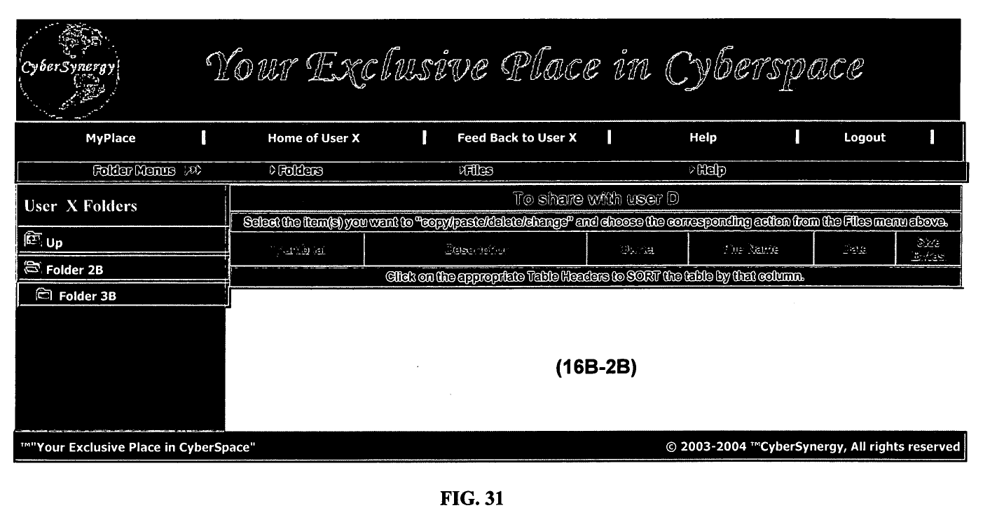

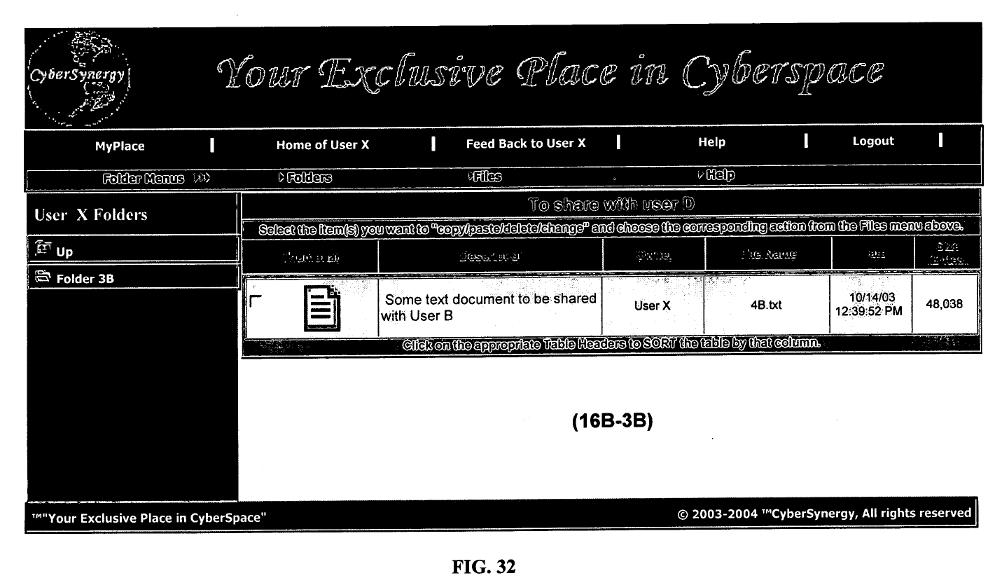

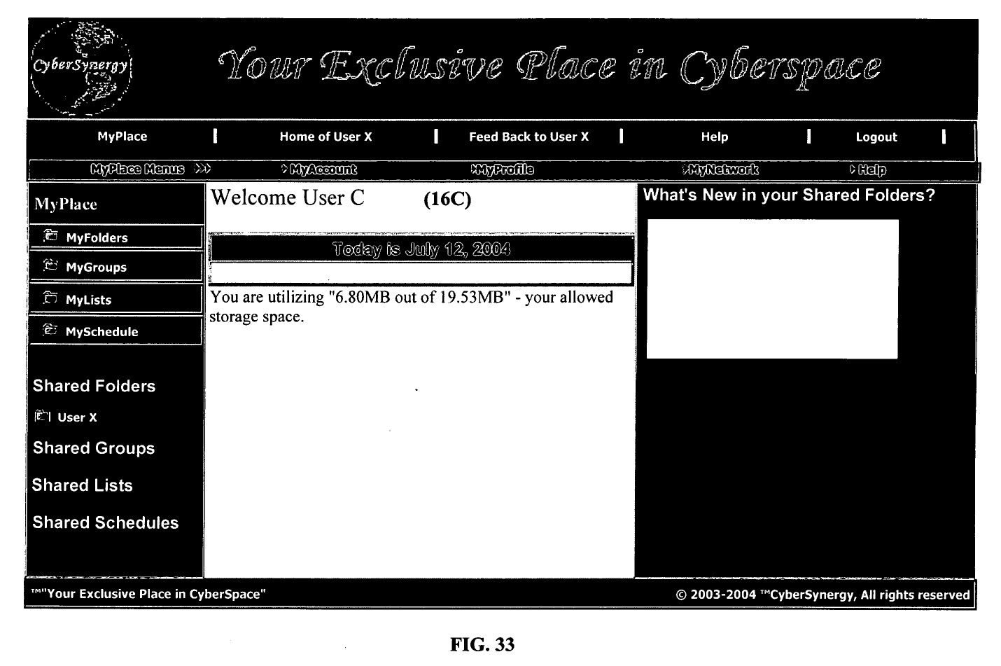

When User B logs onto system 101 after he or she has been granted access to File 4B, he or she will see
User X under Shared Folders, as shown in FIG. 28 (16B).
When User B has clicked on User X, User B will ONLY see Folder1B, as shown in FIG. 29 (16B-X).
When User B has clicked on Folder 1B, User B will ONLY see Folder 2B, as shown in FIG. 30 (16B-1B).
When User B has clicked on Folder 2B, User B will ONLY see Folder 3B, as shown in FIG. 31 (16B-2B).
When User B has clicked on Folder 3B, User B will see File 4B, as shown in FIG. 32 (16B-3B).

Since the dropdown Menus are Access (READ) context sensitive, the User B will also see:
Nothing under Folder dropdown menu 264
Only Copy File from File dropdown menu 266
   Case 3: User C has READ+WRITE Access to User X's Shared Folder 3C

Let us consider an example of User C having READ+WRITE access to shared asset Folder 3C, belonging to User X. The series of screenshots FIGS. 16C-xx shows various views as seen by user C.
When User C is granted an access to Folder 3C, the system automatically adds Transient access UC-T to the root node of User X and to the nodes Folder 1A and Folder 2A. The transient access enables system 101 To display the root node of User X as a shared node under User C's account; and
To guide user C to Folder 3C.

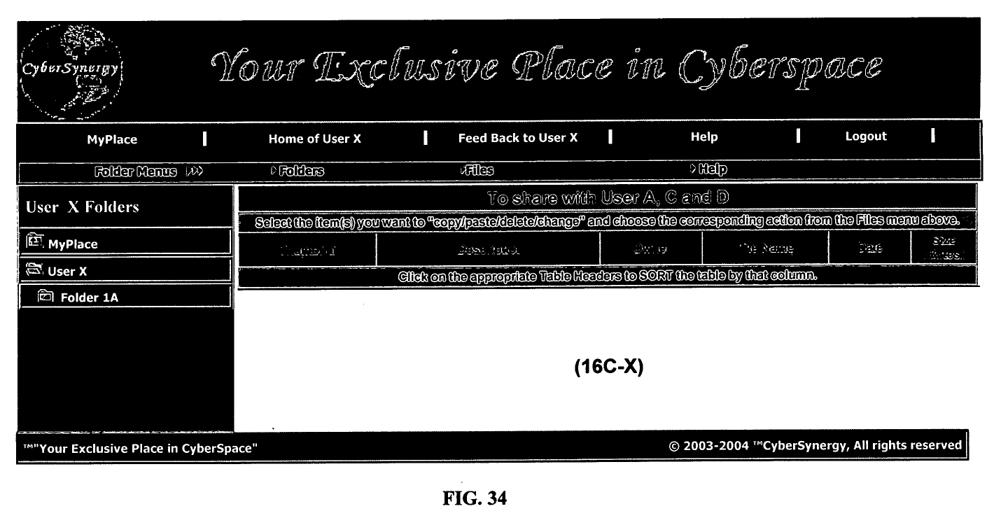

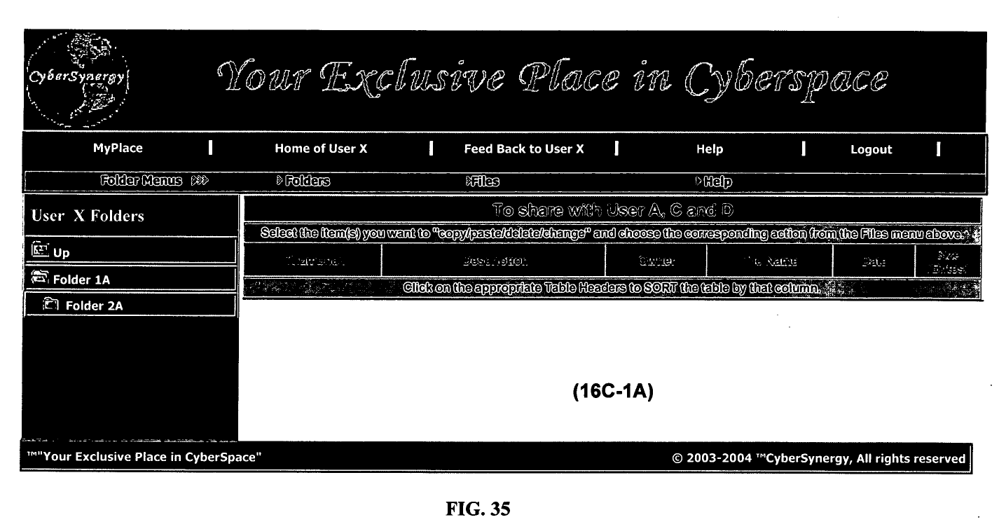

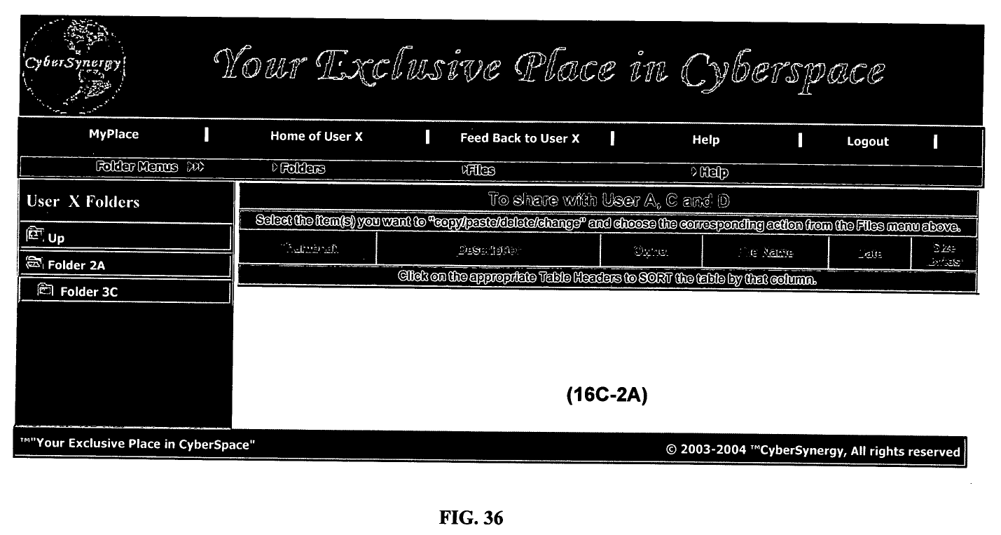

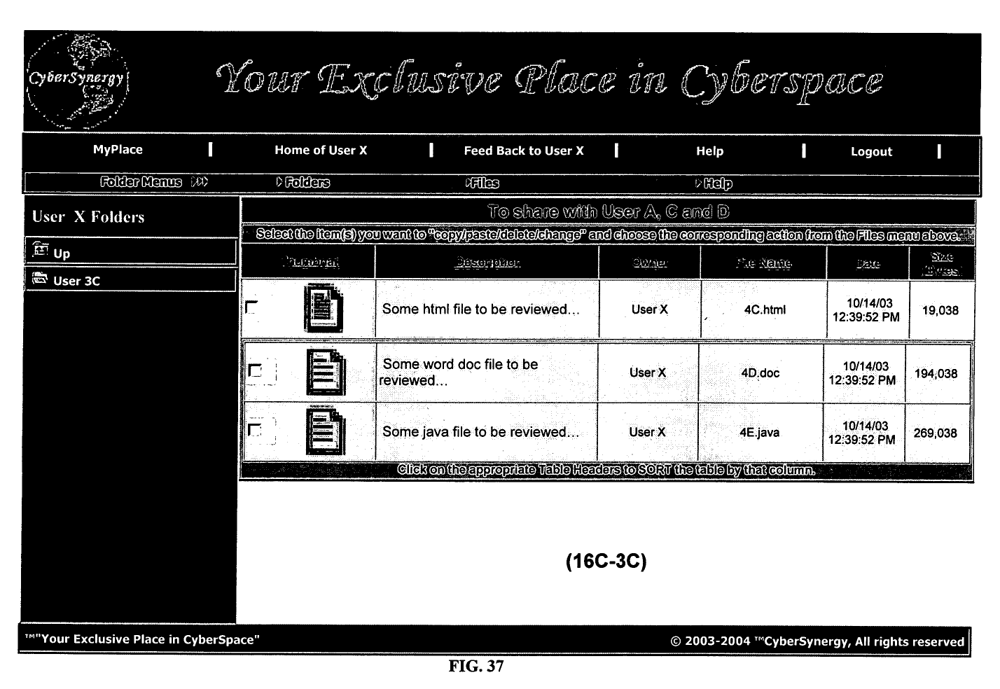

When User C logs into system 101, he or she will see
User X under their Shared Folders, as shown in FIG. 33 (16C).
When User C has clicked on User X, all User C will see is Folder 1A, as shown in FIG. 34 (16C-X).
When User C has clicked on Folder 1A, User C will see Folder 2A, as shown in FIG. 35 (16C-1A).
When User C has clicked on Folder 2A, User C will see Folder 3C, as shown in FIG. 36 (16C-2A).
When User C has clicked on Folder 3C, User C will see File 4C, File 4D and File 4E, as shown in FIG. 37 (16C-3C).

Since the Dropdown Menus are Access (READ+WRITE) context sensitive, the User C will also see:
Add File, and Add Folder menus under the Folder dropdown menu; and Add File, Paste File, Change description for File menus under the File dropdown menu
   Case 4: User D has FULL access to User X's Shared Root Node

Let us consider an example in which User D has FULL access to User X's entire access hierarchy. When User D is granted Full access to the root node of User X's asset hierarchy, system 101 adds a Transient access UD-T to not only the root node of User X but also to all other non-leaf nodes. Because User D has full access, he or she will be able to every thing User X will be able to do.
system 101 will display the root node of User X as a shared node in User D Folders 232.

When User D logs into his system, he or she will see
User X under the Shared Folders together with other users who share assets with User D.
When User D has clicked on User X, User D will see Folder1A, File 1A and Folder 1B, as shown in FIG. 17 (16X-0).
From this in the series of FIGS. 17 through 25 (16X-xx)

Since the dropdown menus are access context sensitive and User D has FULL access, the menus User D sees for User X's files and folders are the same ones that User X sees.

User Access Seen Asset Owner (UASAO) Model 910: FIG. 9

Even though the UAAO model resolves DELAY figuring out in the shared assets, ensures that the GUI user sees only his own assets and assets that other users have shared with him, and helps guide the GUI user to the assets that have been shared with him, we still need a way to figure out “what shared asset has been seen by a user” and need to keep track of the path to the unseen asset from the root node of the root node of the asset tree belonging to the owner of the asset. This can be accomplished by simply adding another field, seen/unseen, to UAAO model 810 to produce UASAO model 910, shown in FIG. 9.

Entries for Transient access in UASAO model 910, as shown in FIG. 9, contain the following 5 items:
what Asset? 812 (unique Asset Id);
belonging to Whom? 811 (unique asset Owner Id);
is shared with Whom? 814 (unique recipient's User Id);
with the Access Type 815 (Access Type: Read, Read+Write, Read+Write+Delete, Full, Remove and Transient);
is the asset Seen/Unseen 916 by the recipient (seen/unseen flag)

The last field, Seen/Unseen, is a flag that is set and cleared by system 101.

Description of the Seen/Unseen Field in the UASAO Model:

FIG. 6 shows a typical directory tree hierarchy 601 for user X superposed with the UASAO tags. We have already extensively discussed Transient Access. _When User X adds a NEW file File 4F under Folder 3A,
The system first adds the file File4F under the Folder 3A.
The system adds Transient access entries UA-T and UD-T (shown in dotted lines) for the file File4F. The added access carries the information that the file is “unseen” by User A and User D.
The system also adds Transient access entries UA-T and UD-T for Folder 3A, Folder 2A, and only UD-T for Folder 1A, as there is already a UA-R present and the transient access will be needed to make the new file accessible to User A and User D and to guide the users to File 4F.
There is only be one Transient access entry per node per user, and it will be reused to mark and unmark the path in future.
In addition, the system will mark all the Transient access entries for the nodes along the path from the Root Node to File 4F as unseen, namely: User X Home directory, Folder 1A, Folder 2A and Folder 3A.

When User A or User D actually follows the path, each of the Transient access entries for to the nodes along the path is marked as “Seen” and finally the Transient access entries for File 4F itself, when its seen, will be deleted, since there is no need to keep the flag value after the asset has been' seen.

Implementation of User Access Seen Asset Owner (UASAO) Model:

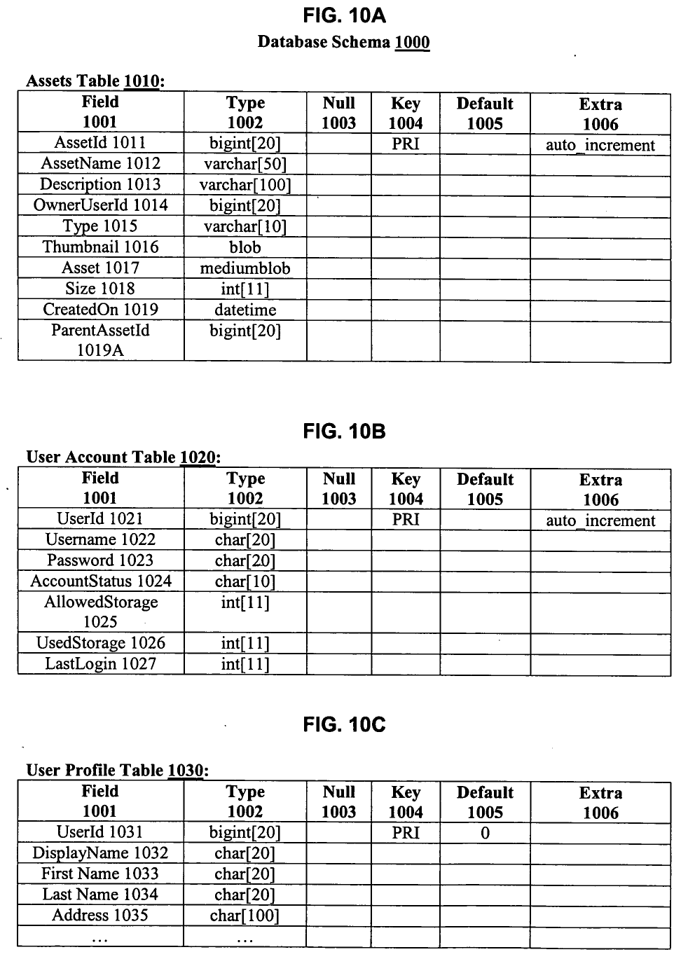

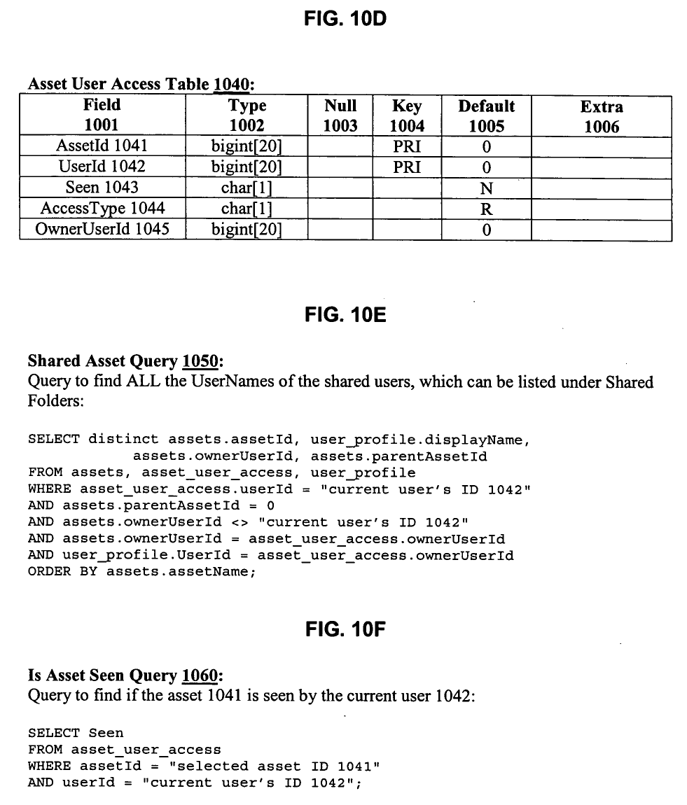

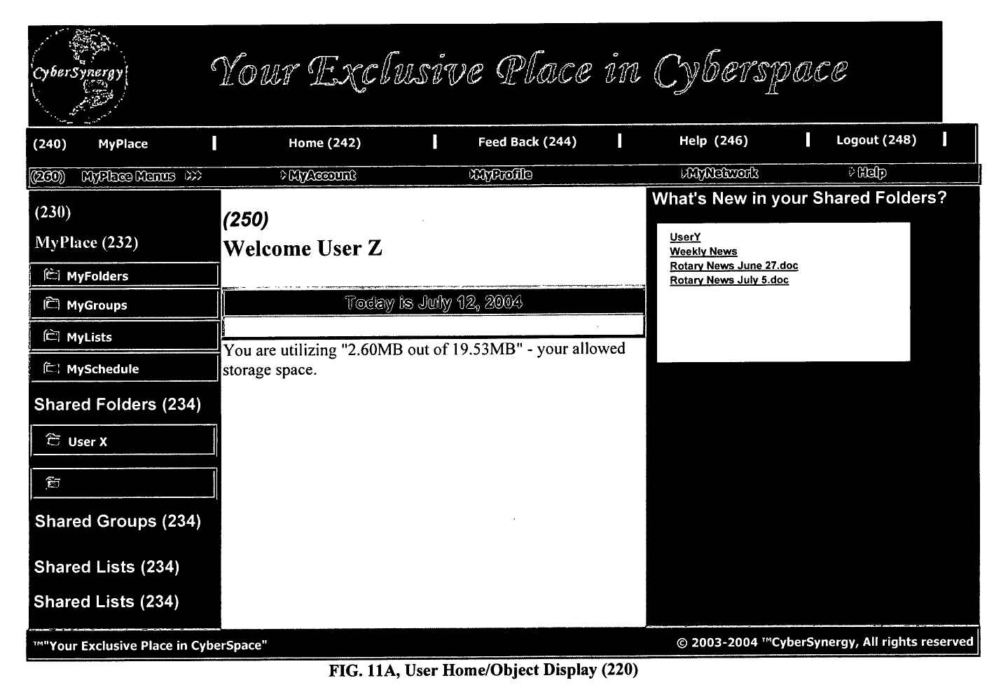

System 101 implements data storage 130 as a relational database. Part of this database is user info 131, another part is user/asset relationships 132, and a third is assets 133. User-asset table 132 implements the access relationships between users and assets. FIGS. 10A, 10B, 10C, and 10D show some of the relevant tables of the schema for the relational database used by system 101.

Assets Table 1010, as shown in FIG. 10A, shows the detailed metadata stored for each asset. Most of the field names 1001 are self-explanatory. AssetName field 1020 is the name by which the asset will be known in system 101's GUI. ParentAssetID is the identifier of the asset that is the parent of the asset represented by the entry in the asset hierarchy of the asset's owner. Thumbnail 1016 is stored as a “blob” data item when the asset is a file with graphic components. In the preferred embodiment, the asset is actually stored in the database; in other embodiments, the entry for an asset may contain a specifier for the actual location of the asset.

User Account Table 1020, as shown in FIG. 10B, shows the detailed metadata stored for each user. The fields are again self-explanatory. Username field 1022, which MUST be unique, and Password field 1023 contain the username and password that the user identified by UserId 120 must use when he or she logs onto the system. Only users for whom AllowedStorage 1025 is not 0 may own assets on system 101.

User Profile Table 1030, as shown in FIG. 10C, shows the detailed metadata stored for each user. Again, the contents of the fields are clear from the fields' names. DisplayName field 1032 is the name for the user identified by UserID 1032 which will be used for the user in the GUI of system 101.

Asset User Seen Access Owner Table 1040, as shown in FIG. 10D, contains the information used for access control and to guide users to shared objects that they have not yet seen. There is an entry in Asset User Seen Access Owner Table 1040 for each user for each asset that the user has explicitly been given access to by another user who has FULL access to the asset. Accordingly, AssetId 1041 represents the asset, UserId 1042 represents the user whose access to the asset is represented by the entry, and AccessType 1024 identifies the kind of access the user has to the asset. Seen 1043 is used to flag unseen assets. OwnerUserId field 1045 identifies the owner of the asset. In the presently-preferred embodiment, any user with FULL access to an asset may modify or delete any entry in table 1040 for the asset. Other embodiments may require that the user who modifies or deletes the entry be the one who explicitly gave the access represented by the entry. In such an embodiment, entries in table 1040 would have an additional field that contained the user id of the user who explicitly gave the access.

As an example of how system 101 maintains table 1040, consider how table 1040 changes when User X gives User B Read access to file 4B (Case 2 of FIG. 6). There are two ways in which this can happen:
User X adds file 4B to folder 3B in User X's asset tree and User B has at least Read access to Folder 3B either explicitly or by inheritance; or
File 4B already exists in Folder 3B and User X explicitly gives User A access to file 4B.

Beginning with the first of the above cases, when User B has at least Read access to folder 3B and User X adds file 4B to folder 3B, file 4B inherits User B's access to folder 3B. In this case, Authorize 214, which manipulates table 1040, creates a new entry in table 1040 which gives User B Transient access to file 4B. In this entry, Seen flag 1043 is set to Unseen, indicating that User B has not yet seen file 4B. Authorize 214 next determines whether there is a Transient access entry in table 1040 for User B and Folder 3B; if there is one, Authorize 214 sets Seen flag 1043 to Unseen; if there is no such Transient access entry, Authorise 214 makes one. Authorize 214 does the same for User B and folder 2b, folder 1B, and User X's root node. In moving up the asset tree, Authorize 214 uses Parent AssetId 1019A field of the Assets table entries for file 4B, folder 3B, folder 2B, and folder 1B.

In the second case, User X explicitly gives User B access to file 4B. As shown in FIG. 15, User X does this by selecting file 4B for access modification, filling in the DisplayName 1032 for User B, selecting Read access, and then clicking on the modify access button. When User X does this, Modify Entity Attributes 266 then calls Authorize 214. Authorize 214 does the following:
It creates an entry in Asset User Access Table 1040 that gives User B read access to file 4B. Accordingly, AssetId field 1041 contains the identifier for file 4B, UserId field 2042 contains the user id for user B, Seen field 1043 is set to a null value, AccessType field 1044 is set to Read, and OwnerUserID field 1045 is set to User X.
It creates an entry in Table 1040 that gives User B Transient access to file 4B. The fields are set as described for the Read entry, except that Access Type is set to Transient and Seen is set to Unseen.

Authorize 214 then moves up User X's hierarchy of owned assets and makes or sets transient asset entries for User B as already described for the first case.

In either of the above cases, when User B next clicks on MyPlace 240, file 4B and the part of User X's hierarchy that includes file 4B will be accessible to User B when User B clicks on User X in Shared Folders 234. To indicate that a new asset has become accessible, User X will be displayed in red instead of blue. as will the lower levels of the hierarchy down to file 4B. Authorize 214 finds the access User X needs to reach file 4B in the Transient access entries that Authorize created when file 4B became accessible to User B. Also contained in the Transient access entries and retrieved by Authorize 214 is the information needed to display the path to the asset in red. It is displayed in red because the Seen field in the Transient access entries for the assets in the path is set to Unseen.

When User B performs an action which gives file 4B seen status with respect to User B, Authorize 214 traverses the Transient access entries in Asset User Access Table 1040 for the access rights that are required by User B access file 4B. In each Transient access entry for User B and an asset on the path to file 4b except the Transient access entry for file 4B, Authorize 214 sets Seen field 2043 to indicate that User B has seen the entry. Authorize 214 simply removes the Transient access entry for file 4B from table 1040. Because the Seen flags have been reset and the Transient access entry for file 4B has been removed, the next time User B sees the path to file 4B, it will appear in blue.

When file 4B is deleted or a user with FULL access to file 4B removes User B's read access to file 4B, Authorize 214 deletes the entry in Asset User Access Table 1040 for User B and file 4B. If there are no other assets in folder 3B to which User B has access, Authorize 214 removes the entry that gives User B transient access to folder 3, and so on for each of the other folders between folder 3B and User X's root node. In the case of deletion, of course, the same must be done with regard to all users that have either explicit or inherited access to file 4B. Authorize 214 must of course perform similar cleanups when a user is deleted from system 101.

FIGS. 10E and 10F shows some of the relevant SQL query statements used to query the database schema used by system 101. SQL queries are used to determine the access rights of the user each and every time the user clicks on any shared assets or the refresh button.

Shared Asset Query 1050, shown in FIG. 10D, is an example of a Query to find ALL the Usernames 1042 of users with which the user for which system 101 is making the query shares assets. These names are then listed under Shared Folders 234.

Is Asset seen Query 1060, as shown in FIG. 10E, is an example of a Query to find if an asset has been seen by the user for which system 101 is making the query.

### CONCLUSION

The foregoing Detailed Description has disclosed to those skilled in the relevant technologies how to make and use the inventor's system for accessing digital assets and has further disclosed the best mode presently known to the inventor of implementing his system. It will however be immediately apparent to those skilled in the relevant technologies that the implementation of the invention disclosed in the Detailed Description is only one of many possible implementations. For example, the disclosed implementation of the claimed system whereby users may access digital objects implements the system in a Web server and uses a browser as the user interface. Systems that incorporate the principles of the invention may, however, be implemented for any kind of arrangement which gives users access to digital assets. For instance, an operating system may have a user interface to its file system that incorporates the principles of the invention. Similarly, in the disclosed embodiment, assets have owners and the embodiment organizes the assets into a forest of trees, with one tree for each owner. Embodiments of the invention can however be made which employ any useful way of organizing the assets.

There are further many different ways of implementing features of the invention. For example, any method permitted by a system's graphical user interface may be used to indicate assets that the user has not yet seen and guide the user to those assets. Embodiments of the invention may employ any kind of user interface which can display and receive the necessary information for the operations performed by the invention. There are further many different ways of representing the access relationships of the invention; any representation can be employed in the invention which has two characteristics: the representation can specify access by a particular user to a particular asset and the representation permits determination of what assets a given user has access to in an amount of time which makes the determination usable in an interactive interface.

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A system whereby users may access digital assets,
the system comprising:
an access relationship representation of access relationships between the assets and the users, an access relationship indicating one of a plurality of kinds of access by a particular user to a particular asset;
an access checker that employs the access relationship representation to produce a determination of what assets a given user may access; and
an interactive user interface that includes an asset access interface that employs the access checker whenever the asset access interface is used by the given user of the system to make the determination and uses the determination to indicate to the given user only those particular assets which the given user may currently access.

2. The system set forth in claim 1 wherein:
the access relationship for a particular user and a particular asset indicates whether the particular user has accessed the particular asset since the access relationship was established; and
the asset access interface indicates assets which the given user has not accessed since the access relationship was established differently from other assets that the user may currently access.

3. The system set forth in claim 1 wherein:
the assets are organized into a hierarchy; and
the asset access interface indicates a path through the hierarchy for any asset to which the given user currently has access.

4. The system set forth in claim 3 wherein:
there is a plurality of the hierarchies; and
a given hierarchy of the plurality belongs to a given user of the system.

5. The system set forth in claim 3 wherein:
the system includes storage controlled by users;
assets stored in storage controlled by a user are organized into a hierarchy belonging to the user; and
any user of the system who has the proper access to a user's hierarchy may add an asset to the user's storage.

6. The system set forth in claim 1 wherein:
the assets are organized into a hierarchy; and
the kind of access which a particular user has to a particular asset may be inherited from an asset that is above the particular asset in the hierarchy and to which the particular user has access.

7. The system set forth in claim 1 wherein:
the user interface notifies the given user when there is a change in the assets to which the given user currently has access.

8. The system set forth in claim 1 wherein:
the given user identifies himself to the system by presenting credentials to the system; and
when the system has accepted the credentials, the given user may access any of the particular assets without further credentials.

9. The system set forth in claim 1 wherein:
the interactive user interface provides outputs to and receives inputs from a Web browser.

10. The system set forth in claim 1 wherein:
the assets include files which users have made available to the system.

11. The system set forth in claim 1 wherein:
the assets include information about themselves which users have made available to the system.

12. The system set forth in claim 1 wherein:
the kinds of access relationships include an access granting relationship which permits a particular user having the access granting relationship to a particular asset to give access to the particular asset to another user, the other user being determined by the particular user giving access and the system further comprises:
an access granting interface in the interactive user interface by which a given user having the access granting relationship to a given asset can establish an access relationship in the access relationship representation which gives another user access to the given asset.

13. The system set forth in claim 12 wherein:
any given user who has an access granting relationship to a given asset may use the access granting interface to establish an access granting relationship in the access relationship representation for the other user and the given asset.

14. The system set forth in claim 13 wherein:
the assets are organized into a plurality of hierarchies;
a given hierarchy of the plurality belongs to a given user of the system; and
the system establishes an access granting relationship in the access relationship representation between the given user and the assets in the given hierarchy.

15. The system set forth in claim 12 wherein:
the assets include objects which identify sets of users;
the system automatically provides a user of the system with an object that identifies a set of users whom the user has invited to access a particular asset; and
when the user has an access granting relationship with the asset, the user may use the access granting interface to establish a particular access relationship for all of the users in the set identified by the object to the given asset.

16. The system set forth in claim 12 wherein:
any given user who has an access granting relationship may use the access granting interface to remove access relationships from the access relationship representation.

17. The system set forth in claim 12 wherein:
the assets include an object which identifies a set of other users; and
any given user who has an access granting relationship may use the access granting interface to establish a particular access relationship for all of the users in the set identified by the object to the given asset.

18. A data storage device, the data storage device being characterized in that:
the data storage device contains code which, when executed in a computer system, implements the system set forth in claim 1.

19. A graphical user interface for a system whereby users may access digital assets, the system including
an access relationship representation of access relationships between the assets and the users, an access relationship indicating one of a plurality of kinds of access by a particular user to a particular asset and
an access checker that employs the access relationship representation to produce a determination of what assets a given user may access and the graphical user interface comprising:
asset indications presented to the given user, the asset indications representing only those particular assets which the determination produced by the access checker indicates that the given user may currently access; and
an input device whereby the given user may specify operations concerning assets, the system responding when the given user specifies an operation by using the access checker to produce the determination.

20. The graphical user interface set forth in claim 19 wherein:
the system is accessible via a standard network protocol; and
the graphical user interface is implemented using a browser for the standard network protocol.
